(19) United States
(12) Patent Application Publication
(10) Pub. No.: US 2025/0105935 A1
(43) Pub. Date: Mar. 27, 2025

(54) METHODS AND DEVICES TO PERFORM RADIO COMMUNICATION USING CYCLIC SHIFTS

(71) Applicant: Intel Corporation, Santa Clara, CA (US)

(72) Inventors: Pratik CHANDAK, Dublin, CA (US); Peng LU, Elk Grove, CA (US); Thushara HEWAVITHANA, Tempe, AZ (US); Samuel WONG, Walnut, CA (US); Michael BEADLE, Tustin, CA (US)

(21) Appl. No.: 18/474,276

(22) Filed: Sep. 26, 2023

(51) Int. Cl. H04B 17/309; H04L 27/26

(52) U.S. Cl. CPC H04B 17/346; H04L 27/2605

(57) ABSTRACT

A radio communication device may include: a memory; and a processor configured to: determine a received radio signal including payload information from a plurality of mobile radio communication devices, wherein the payload information is mapped to a resource block via a plurality of cyclic shifts; for each mobile radio communication device of the plurality of mobile radio communication devices, determine a candidate cyclic shift applied to a respective payload information of the payload information, wherein the candidate cyclic shifts for the plurality of mobile radio communication devices are determined from a plurality of candidate cyclic shifts; and perform a noise power estimation using other candidate cyclic shifts of the plurality of candidate cyclic shifts, wherein the other candidate cyclic shifts are not determined as the candidate cyclic shifts.

### TECHNICAL FIELD

This disclosure generally relates to methods and devices to perform radio communication using cyclic shifts (CSs).

### BACKGROUND

In radio communication networks in accordance with many radio communication technologies, such as Fourth Generation (LTE) and Fifth Generation (5G) New Radio (NR), various methods are employed to provide wireless data transfer with desired efficiency, speed, and reliability. One of these methods involves using CSs, which are designated modifications applied to transmit signals. CSs are generally employed to mitigate interference and enhance the accuracy of signal separation, to increase efficient utilization of available communication channels.

Designated control channels are used in LTE and 5G networks to facilitate the exchange of essential control information between user equipment (UE) and base stations (BSs). For example, the Physical Uplink Control Channel (PUCCH) is used to transmit channel state information (CSI) feedback, hybrid automatic repeat request (HARQ) acknowledgments, and scheduling requests (SR). The differentiation of signals from multiple UEs within a limited frequency and time resource may be challenging, especially in scenarios of high congestion. For implementation, Long PUCCH and Short PUCCH Formats have been developed for various scenarios related to channel conditions, data payloads and resource allocation.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an exemplary illustration of a resource grid for radio communication, complimenting the resource grid of LTE/5G;

FIG. 4 exemplarily shows an illustration of CSs applied to signal HARQ acknowledgements and scheduling requests;

FIG. 5 illustrates an example of a radio communication network in accordance with various aspects of this disclosure;

FIG. 6 shows an example of an apparatus of a radio communication device according to various examples in this disclosure;

FIG. 7 shows an exemplary flow diagram to decode respective payload information of multiple mobile radio communication devices in accordance with various aspects provided herein;

FIG. 8 shows an exemplary flow diagram to decode the respective payload information of multiple mobile radio communication devices in accordance with various aspects provided in this disclosure;

FIG. 9 shows an exemplary flow diagram illustrating some aspects that the processor may perform for classifying the candidate CSs;

FIG. 10 shows an exemplary flow diagram illustrating some aspects that the processor may perform to calculate signal and noise power;

FIG. 11 shows an example of a method.

### DESCRIPTION

The following detailed description refers to the accompanying drawings that show, by way of illustration, exemplary details and aspects in which aspects of the present disclosure may be practiced.

CSs used in radio communication involve applying controlled phase offsets to transmitted signals, for various purposes including enabling enhanced signal separation and efficient resource utilization, in particular, in congested network environments. Using CSs in radio communication may take various forms including, a transmitter (i.e. a transmitting entity) using CSs to modify the waveform of the transmitted signal. Aspects may include applying a specific CS value to an original signal (e.g. radio communication signal) at the transmitter, before sending the transmit signal. The transmit signal, which is a cyclically shifted signal, is then transmitted through the air. At the receiving end, the receiver correlates the received signal with various cyclically shifted versions of the expected signal. In essence, the correlation process helps identify which CS was by the transmitter to obtain the transmit signal. This way, the receiver may distinguish and decode multiple signals (e.g. from multiple transmitters) that might overlap in the transmission channel.

The application of CSs are employed in scenarios like the Physical Uplink Control Channel (PUCCH) within LTE and 5G networks, where efficient signal separation is essential for reliable communication in high-traffic conditions. For example, in PUCCH, each user equipment (UE) applies a distinct CS to its respective transmit signal before sending it to the BS. This CS may be considered to introduce a controlled phase offset, which the BS may effectively separate and decode signals from multiple UEs sharing the same time-frequency resource based on introduced CSs. By employing different CSs, UEs may create designated signal signatures, allowing the BS to identify the transmitting entities (i.e. which UEs of multiple UEs) and decode accordingly.

As radio communication networks become increasingly complex, certain scenarios may be encountered, in which multiple radio signals transmitted by multiple transmitters are multiplexed in the same time (e.g. OFDM symbol) and frequency resources. However, in such environments, the number of CSs that are available or designated for the transmitters might be insufficient for operation, in particular considering the need of accurate noise power estimations with known methods. Particularly, when all PUCCH resources are allocated, the current approach may take decoding decisions based on outdated or inaccurate noise power estimates, and preventing to adapt to the dynamic changes in noise and interference within the PUCCH signal.

When multiple transmit signals are multiplexed in the same time and frequency resources (radio communication resources), the number of CSs designated for radio communication may be insufficient to estimate the noise power with desired accuracy using conventional methods. For example, in the context using CS for PUCCH, a predetermined number of CSs may be designated for a number of UEs. Accordingly, when all PUCCH resources (e.g. CSs) are occupied, the BS may not perform noise power estimations with a desired accuracy or may rely on noise power estimations performed at a time instance which does not reflect current radio communication channel conditions. Accordingly, the BS may not be able to adapt to dynamic changes in noise and interference in the PUCCH signal.

The above-mentioned scenarios are likely to be considered for use of short PUCCH resources, i.e. when designated time and frequency resources are to be used. For example, when multiple UEs are scheduled and code multiplexed in the same OFDM symbol and frequency resources, the resource to be used for noise power estimation may be significantly reduced if the BS uses the unoccupied code resource for noise power estimation. Correspondingly, when, for example, PUCCH Format 0 is used, symbol detection performance of PUCCH Format 0 symbol detection may degrade since symbol detection methods are likely include a threshold to be applied for the decoding decision (i.e. determining a transmit symbol (e.g. payload information), that is transmitted by the respective UE), and thresholding operation using this threshold may depend on the accuracy of noise power estimation. Moreover, the closed-loop power control commands, which may usually be based on the received signal signal-to-noise ratio (SNR), may not be generated with a desired reliability.

In accordance with various aspects provided in this disclosure, a radio communication device (e.g. a BS) may receive a radio signal, and the radio signal may include transmit signals of multiple mobile radio communication devices (e.g. multiple UEs). A transmit signal of a respective mobile radio communication signal may include a respective payload information sent by the respective mobile radio communication device to the radio communication device. Particularly, the multiple mobile radio communication devices may use the same time and frequency resources to send the payload information. In other words, the payload information carried by the radio signal, which the payload information may include the respective payload information of the multiple radio communication devices, may be mapped to a particular resource block.

In accordance with various aspects, the radio communication between the radio communication device and the multiple mobile radio communication devices may involve using a plurality of CSs. The plurality of CSs may be designated by any entity, and may be predetermined. Each mobile radio communication device of the plurality of mobile radio communication devices may be configured to use one or more CSs of the plurality of CSs. The one or more CSs used by one of the mobile radio communication devices may be distinct (i.e. different) from CSs used by other mobile radio communication devices. The radio communication device may, by determining CSs used in the radio signal, identify the mobile radio communication devices sending their respective payload information, and may also decode their respective payload information.

In accordance with various aspects, the radio communication device (e.g. a processor of the radio communication device) may determine CSs used in the radio signal. The radio communication device may employ various methods to determine CSs in the radio signals, which the mobile radio communication devices have used to obtain their respective transmit signals. Such methods may include estimating CSs (i.e. amount of CSs, amount of phase offset) used in the radio signal iteratively based on the plurality of CSs (i.e. possible CSs that can be used by the multiple radio communication devices, CSs that the multiple mobile radio communication devices are or have been configured to use).

In accordance with various aspects, the radio communication device (e.g. a processor of the radio communication device) may perform decoding operation to decode the respective payload information sent by each mobile radio communication device based on an estimation of noise power. Various aspects are provided in this disclosure with respect to how the radio communication device may perform a noise power estimation for radio signals including payload information of the multiple mobile radio communication devices, in which the multiple mobile radio communication devices have obtained their respective transmit signals based on their respective payload information and their respective CSs.

In accordance with various aspects described herein, the radio communication device may perform symbol detection/decoding based on a greater amount of CSs compared to conventional methods. In particular, when all available CSs are allocated to PUCCH are utilized, noise power estimations can be performed for the same block. Furthermore, in multiple input multiple output (MIMO) radio communication, combining method across OFDM symbols and antennas may help in identifying the CSs applied by the mobile radio communication devices.

In accordance with various aspects described herein, the radio communication device (e.g. a processor of the radio communication device) may scan across all mobile radio communication devices and may identify the CS applied by each mobile radio communication device of multiple mobile radio communication devices. The identification of the CS applied by each mobile radio communication device may include selecting one candidate CS among candidate CSs specific to the respective mobile radio communication device. In various examples, the candidate CS that achieves the maximum correlation power (i.e. the highest correlation magnitude) is selected. Further, the radio communication device may perform noise power estimation based on other candidate CSs from the candidate CSs. The noise power estimation may further be based on further CSs that are also not used by another mobile radio communication device.

In some aspects, the radio communication device may employ a symbol and/or discontinuous transmission (DTX) detection based on an applied thresholding with respect to received radio signals, in particular based on calculated correlation power and noise power estimates. The radio communication device may perform peak to noise power calculations by combining received signals across antennas and OFDM symbols. Accordingly, an optimal performance for both DTX to ACK and ACK missed detection probability can be achieved for the radio communication device. Thus, the radio communication device may operate with an optimum signal-to-noise ratio. Illustratively, the radio communication device may detect payload information, such as payload of PUCCH Format 0, at SNRs lower than conventional methods and accordingly extend the coverage of the radio communication network. Aspects may further result in an improvement of downlink throughput, as retransmissions are to be reduced in comparison with conventional methods. Aspects particularly include reducing computation complexity.

The apparatuses and methods of this disclosure (i.e. radio communication devices and mobile radio communication devices, together with methods described herein) may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System in 3.55-3.7 GHZ and further frequencies), and may use various spectrum bands including, but not limited to, IMT (International Mobile Telecommunications) spectrum (including 450-470 MHz, 790-960 MHz, 1710-2025 MHz, 2110-2200 MHZ, 2300-2400 MHZ, 2500-2690 MHz, 698-790 MHz, 610-790 MHZ, 3400-3600 MHZ, etc., where some bands may be limited to specific region(s) and/or countries), IMT-advanced spectrum, IMT-2020 spectrum (expected to include 3600-3800 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHz, 38.6-40 GHz, 42-42.5 GHZ, 57-64 GHZ, 64-71 GHZ, 71-76 GHZ, 81-86 GHz and 92-94 GHz, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHz), WiGig Band 2 (59.40-61.56 GHZ) and WiGig Band 3 (61.56-63.72 GHZ) and WiGig Band 4 (63.72-65.88 GHz), the 70.2 GHZ-71 GHz band, any band between 65.88 GHz and 71 GHZ, bands currently allocated to automotive radar applications such as 76-81 GHZ, and future bands including 94-300 GHz and above. Furthermore, the apparatuses and methods described herein can also employ radio communication technologies on a secondary basis on bands such as the TV White Space bands (typically below 790 MHZ) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

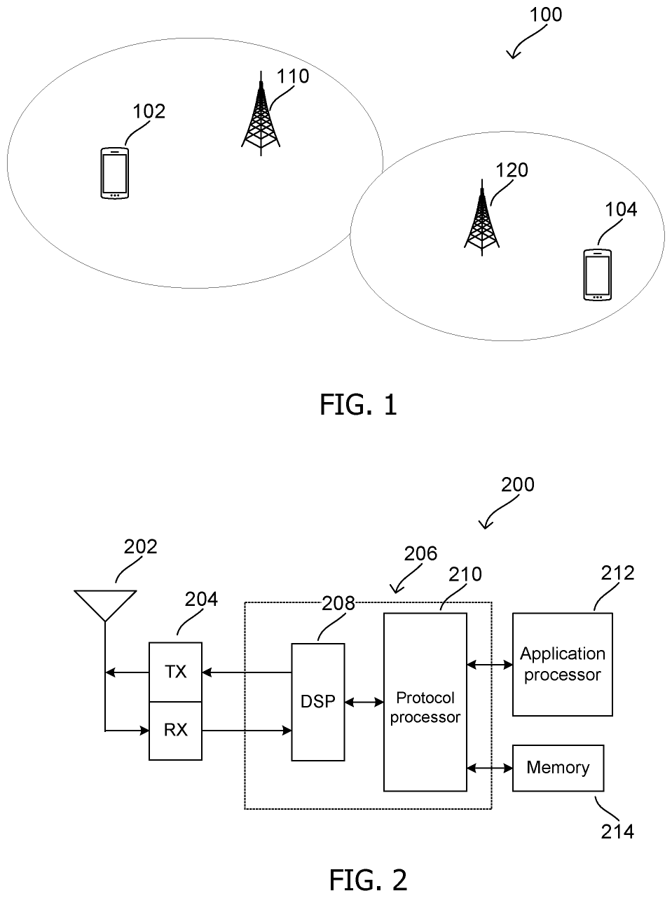

FIGS. 1 and 2 depict a general network and device architecture for wireless communications. In particular, FIG. 1 shows exemplary radio communication network 100 according to some aspects, which may include terminal devices 102 and 104 and network access nodes 110 and 120. Radio communication network 100 may communicate with terminal devices 102 and 104 (i.e. mobile radio communication devices) via network access nodes 110 and 120 (i.e. radio communication devices) over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an exemplary internal configuration of a communication device according to various aspects provided in this disclosure. The communication device may include various aspects of radio communication devices (e.g. network access nodes 110, 120) or various aspects of mobile radio communication devices (e.g. terminal device 102, 104) as well. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAS), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with various aspects provided herein, at least one of baseband modem 206 or application processor 212 may perform processing to provide aspects disclosed herein. For example, for a mobile radio communication device, at least one of baseband modem 206 or application processor 212 may obtain payload information to be sent to a radio communication device. Further, at least one of baseband modem 206 or application processor 212 may apply a designated CS to a communication signal including the payload information. Accordingly, antenna 202 transmits a transmit signal including designated CS applied radio communication signal. Alternatively, for example, for a radio communication device, baseband modem 206 (or application processor 212) may receive radio signal, and at least one of baseband modem 206 or application processor 212 may determine CSs used within the received radio signal. Further, at least one of baseband modem 206 or application processor 212 may perform a noise power estimation as described in this disclosure.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

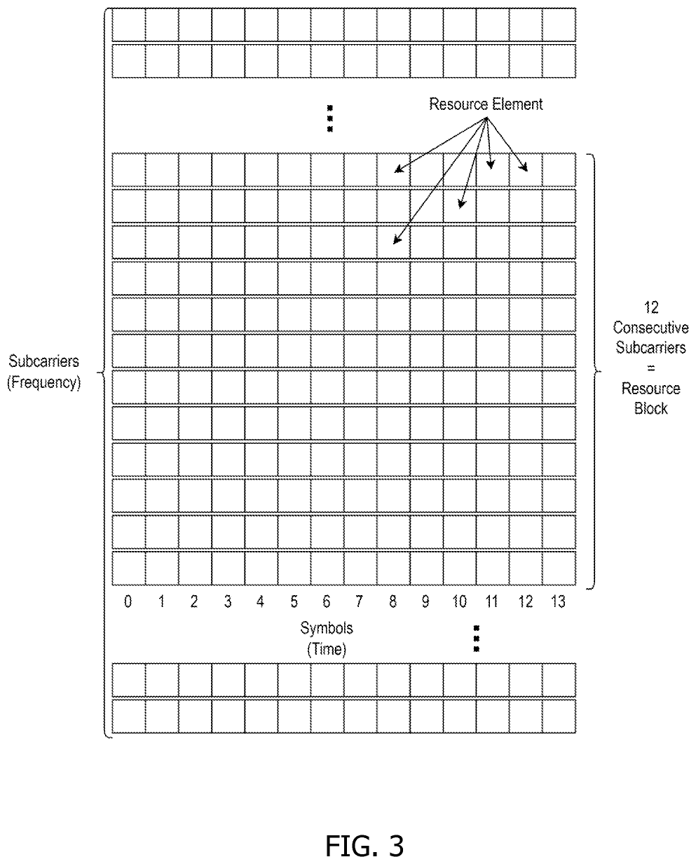

FIG. 3 shows an exemplary illustration of a resource grid for radio communication, complimenting the resource grid of LTE/5G. The resource grid represents time and frequency resources to perform radio communication, exemplarily in a radio access network. The smallest element corresponding to one time and frequency resource may be referred to as a resource element. Illustratively, in 5G/NR a resource element corresponds to one subcarrier during one OFDM symbol.

A resource block may be defined as 12 consecutive subcarriers in the frequency domain. It is to be considered that, resource block may sometimes be referred to as a physical resource block. To describe time domain limitations of a resource block, further considerations may be made, but minimum time domain length of a resource block can be one OFDM symbol duration. Consecutive 14 OFDM symbols may be referred to as a slot.

Although aspects described in this disclosure may apply to various radio communication signals conveyed via various communication channel, they are particularly related to mobile radio communication using PUCCH. Accordingly, aspects described herein are illustrated according to various characteristics associated with PUCCH, and particularly with PUCCH Format 0, however this should not be taken as limiting. The skilled person would recognize the applicability of aspects to different types of communication using CSs, sometimes in a more generic manner.

The PUCCH may carry control information from UEs to BS. Typically, PUCCH may carry uplink control information (UCI) as payload information, that is sent by the UE to the BS. The UCI may particularly include Hybrid Automatic Repeat Request (HARQ) Acknowledgments for prior downlink transmissions, Scheduling Requests (SRs) for uplink resources, and Channel State Information reports representative of channel conditions (e.g. channel quality metrics) for link adaptation and downlink resource allocation. There are various PUCCH Formats currently employed in 5G/NR. For example, PUCCH Format 0 and PUCCH Format 1 may be used to carry smaller UCI payloads, such as 1 or 2 HARQ bits and an SR). PUCCH Format 2, PUCCH Format 3, and PUCCH Format 4 may carry larger UCI payloads than PUCCH Format 0 and PUCCH Format 1.

As indicated, PUCCH Format 0 may be used to transfer 1 or 2 HARQ bits as acknowledgements and/or an SR. PUCCH Format 0 transmission occupies one resource block in the frequency domain and either 1 or 2 symbols in the time domain. Correspondingly, PUCCH Format 0 occupies 12 or 24 resource elements. In some examples, transmission across 2 symbols can be used to improve coverage. Furthermore, a UE may employ frequency hopping when PUCCH Format 0 is arranged to occupy 2 symbols. In this example, the UE may transmit the first symbol of two symbols using one part of the channel bandwidth and may transmit the second symbol using another part of the channel bandwidth.

Payload information encoded in transmit signal using PUCCH Format 0 may correspond to a particular CS applied to a base sequence. Illustratively, the BS is aware of the base sequence and possible CSs that the UE is configured to apply. In various aspects, the BS may configure the base sequence and CSs applicable by the UE. The base sequence may have a length of 12, which may result in that there is a single entry for each subcarrier and is shared by all UEs assigned to the same frequency and time resources for PUCCH Format 0 transmission. The number of total applicable CSs are predetermined. Illustratively, the BS may configure for all the UEs a total of 12 CSs. For one particular UE among all UEs, the one particular UE being configured for a transmission using a specific frequency/time resource allocation, the number of possible candidate CSs may depend on the type of the payload. If there are multiple UEs, the set of CSs used by different UEs are exclusive and may be determined based on an initial CS (m_0).

It is further to be noted that BS may configure the UEs of further aspects required for radio communication, in particular for PUCCH, such as numerology, frequency band, subcarrier spacing, their corresponding bandwidth parts (BWPs), etc. In particular, when a UE is configured to transmit PUCCH using frequency hopping, the UE may determine corresponding physical RB (PRB) indices for each hop of the frequency hopping for PUCCH transmission, based on, exemplarily, its configured BWP, the number of CSs. Furthermore, the BS may configure the time and frequency resources for the UEs for PUCCH transmission, illustratively via a PUCCH-resourceCommon information element.

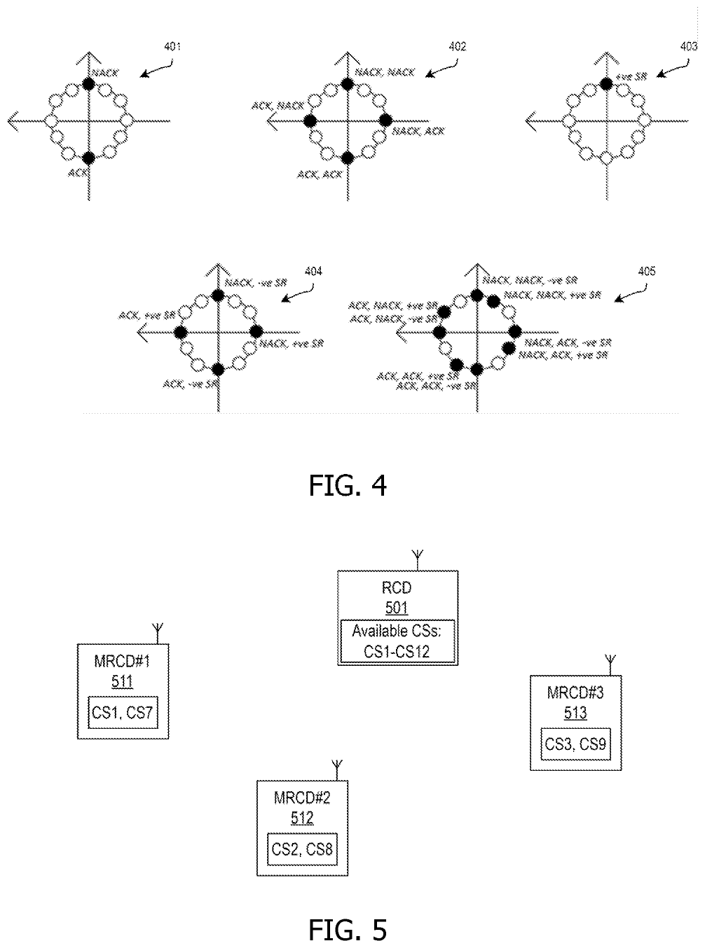

FIG. 4 exemplarily shows an illustration of CSs applied. For example, if a UE is configured to transmit 1 bit UCI as a HARQ acknowledgment 401, for initial CS (m_0) 0, possible candidate CSs for the UE may be 0 (NACK) and 6 (ACK). Alternatively, if the UE is configured to transmit 2-bit UCI as a HARQ acknowledgment 402 with an initial CS (m_0) 0, the possible candidate CSs may be 0 (NACK, NACK), 3 (NACK, ACK), 6 (ACK, ACK) and 9 (ACK, NACK). In a scenario in which multiple UEs including UE1 and UE2, each UE is configured to transmit 1 bit UCI as a HARQ acknowledgment, assuming that UE1 is configured with an initial CS (m_0) 0 and UE2 is configured with an initial CS (m_0) 1, the possible candidate CSs for UE1 are 0 (NACK) and 6 (ACK), and for UE2 are 1 (NACK) and 7 (ACK). Further scenarios are also illustrated, including the UE is configured to transmit an SR 403, the UE is configured to transmit an SR and a 1-bit UCI as HARQ acknowledgment 404, and the UE is configured to transmit an SR and 2-bit UCI as HARQ acknowledgment 405.

A UE encodes information using PUCCH Format 0 within the phase of a reference waveform (sometimes may be referred to as reference signal, reference sequence, or a base sequence). In other words, a transmit signal encoded using PUCCH Format 0 includes cyclically shifted versions of a predetermined reference sequence. The UE may map the cyclically shifted version of a predetermined reference sequence to a resource block in the frequency band occupying 12 consecutive subcarriers and one or two symbols (i.e. 24 resource elements).

In some aspects, and also for brevity, the CS applied to a reference sequence (e.g. a low Peak-to-Average Power Ratio reference sequence) may be denoted as below, in which a denoting the CS applied to the base sequence, NR_{sc}^{RB} denoting the number of subcarriers per resource block, m₀ denoting initial CS for the UE, m_{CS} denoting UCI specific CSS, exemplarily illustrated in FIG. 4 (e.g. 0 and 6 for 1-bit UCI HARQ acknowledgement), and prbs denoting a function based on a pseudo-random binary sequence that is based on the slot number in the frame, OFDM symbol number for PUCCH transmission and index of the OFDM symbol in that slot corresponding to first OFDM symbol of the PUCCH transmission:

$$α = \frac{2 π}{{N}_{s c}^{R B}} ( ( {m}_{0} + {m}_{C S} + p r b s ) mod {N}_{s c}^{R B} )$$

Furthermore, for the sake of brevity and ease of illustration, a CS described in this disclosure may simply correspond to the characteristics distinguishing between multiple UEs in the corresponding UE group, in particular considering the illustrations provided in this disclosure are for present PUCCH format 0 implementation with a resource block having 12 consecutive subcarriers, a CS (e.g. a candidate CS) may be represented as CS=(m₀+m_{CS})mod 12 (i.e. based on an initial CS for the UE and encoded UCI specific CS).

FIG. 5 illustrates an example of a radio communication network in accordance with various aspects of this disclosure. A radio communication device (e.g. a BS) 501 may receive radio communication signals from multiple mobile radio communication devices (e.g. UEs) including a first mobile radio communication device (MRCD) 511, a second MRCD 512, and a third MRCD 513, for which various aspects are described in this disclosure. Exemplarily, MRCDs 511-513 may send information to the RCD 501 using CSs, exemplarily described in accordance with FIG. 4. In the context of cellular communication, the information sent by the MRCDs 511-513 are carried in a PUCCH via PUCCH Format 0. It is to be noted that various aspects described herein for each device may be implemented by a processor, a memory, and a communication interface.

The RCD 511 may be configured to communicate using a set of CSs, which may also be referred to as available CSs. As illustrated, available CSs for the RCD 511 may accordingly be CS1 to CS12 (i.e. 12 distinct CSs). As described in this disclosure, the number 12 correspond to the illustrative example of cellular communication in which each resource block used by PUCCH Format 0 having 12 consecutive subcarriers allowing 12 distinct CSs, but this is not to be taken as limiting. The RCD 511, as receiver of radio communication signals encoded using multiple CSs from multiple transmitters being MRCDs 511-513, may be configured to a set of CSs, which the set of CSs may be predetermined or predefined. Conventionally, the RCD 511 may store information representative of the set CSs in a memory. This set of CSs (i.e. the available CSs of CS1 to CS12, which may also be referred to as possible CSs for radio communication of this radio communication network) may be considered as the CSs based on which the RCD 511 may decode received radio communication signals. In some aspects, the available CSs may be referred to as all candidate CSs.

Each MRCD 511-513 may be configured to use one or more respective CSs of the available CSs. In other words, each MRCD 511-513 may be assigned one or more respective CSs to be used to communicate with the RCD 501. In the context of cellular communication, and considering the MRCDs 511-513 defining a group (i.e. a UE group), the RCD 501 may configure each MRCD 511-513 of the group to use a set of CSs that is distinct from sets of CSs of other MRCDs of the group (e.g. via a radio resource control (RRC) configuration). The configuration may merely include sending information representative of initial CS (i.e. m₀) for the MRCD.

Analogous to the disclosure of FIG. 4 with respect to 1-bit HARQ acknowledgment CSs, and for brevity, the first MRCD 511 is illustrated to be configured to use a first set of CSs, namely CS1 and CS7, to send uplink signals to RCD 501. The second MRCD 512 is illustrated to be configured to use a second set of CSs, namely CS2 and CS8, to send uplink signals to RCD 501. The third MRCD 513 is illustrated to be configured to use a third set of CSs, namely CS3 and CS9, to send uplink signals to RCD 501. Each set of CSs configured for a respective MRCD of the MRCDs 511-513 may be referred to as a candidate cycle set of the respective MRCD including one or more candidate CSs for the respective MRCD. Namely at this particular instance, candidate CSs for the first MRCD 511 may include CS1 and CS7; candidate CSs for the second MRCD 512 may include CS2 and CS8; and candidate CSs for the third MRCD 513 may include CS3 and CS9. The skilled person would recognize that this illustrative example is provided for brevity, and candidate cycle sets may include more CSs and combination of CSs, exemplarily to cover further UCI information (i.e. other than 1-bit HARQ acknowledgements) within PUCCH Format 0.

The RCD 501 may identify one or more CSs used within a received radio signal and accordingly, when the RCD 501 identifies a CS, the RCD 501 may determine which MRCD of MRCDs 511-513 has sent the payload and also decode the payload accordingly. Identification of a CS may include correlating a received radio signal with multiple reference signals, each reference signal being a CS applied reference sequence (i.e. a reference sequence to which a CS of the available CSs is applied). Illustratively, and assuming that the RCD 501 has scheduled time and frequency resources to the first MRCD 511, the RCD 501 may identify the payload by correlating the radio signal received at the scheduled time and frequency resources for the first MRCD 511 with a first reference signal including a CS1 applied reference sequence to obtain a first correlation value and with a second reference signal including a CS7 applied reference sequence to obtain a second correlation value. The RCD 501 may determine the payload based on the greater correlation value among the first correlation value and the second correlation value. Exemplarily, the second correlation value may be greater than the first correlation value and accordingly, the RCD 501 may determine the payload as, illustratively, a HARQ ACK.

It is however to be noted that in various network configurations and depending on the conditions (e.g. channel quality, cell load, interference, etc.) associated with the radio communication environment, each group of MRCDs may increase and the time and frequency resources for radio communication may be limited, and each MRCD may compete for time and frequency resources. MRCDs may share time and frequency resources for radio communication and interference between uplink signals of MRCDs may increase.

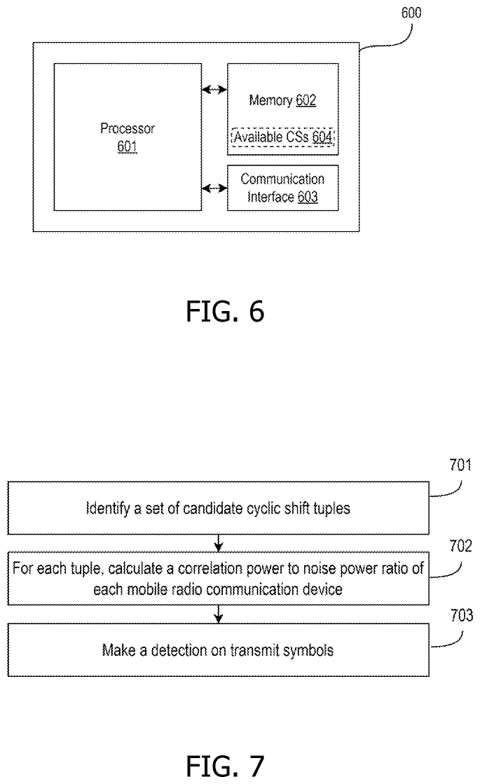

FIG. 6 shows an example of an apparatus of a radio communication device according to various examples in this disclosure. The radio communication device may be a radio communication device (e.g. the RCD 501) of a mobile radio communication network, which the radio communication device may be configured to receive radio communication signals from a plurality of mobile radio communication devices (e.g. the MRCDs 511-513). In cellular communication context, the radio communication device may be a BS (e.g. an evolved node-B (eNB), a next generation node-B (gNB). In a disaggregated radio communication architecture (e.g. Open-Radio Access Network (O-RAN)), the radio communication device may include a distributed unit (e.g. O-DU) or a radio unit (e.g. O-RU) (i.e. depending on the designated split of the protocol stack).

The apparatus 600 may include a processor 601, a memory 602, and a communication interface 603 configured to receive and transmit communication signals in order to communicate with further entities (i.e. the plurality of mobile radio communication devices) within the mobile communication network. In some aspects, the communication interface 603 may include one or more signal paths to carry communication signals. The communication interface 603 may include one or more transceivers.

In some examples, the communication interface 603 may be configured for MIMO communication, and thereby may include a plurality of signal paths. Correspondingly, the transceiver included by the communication interface 603 may be a MIMO transceiver including an antenna interface configured to connect to multiple antennas (e.g. to a MIMO array). In some examples, the apparatus 600 may be configured for performing a frequency hopping operation and the communication interface 603 may further configured for the frequency hopping operation.

The processor 601 may include one or more processors, which may include a baseband processor and an application processor (e.g. application processor 212, baseband modem 206). In various examples, the processor 601 may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 601 may be implemented in one processing unit, e.g. a system on chip (SOC), or a processor. In accordance with various examples, the processor 601 may further provide further functions to process received communication signals. The memory 602 may store various types of information required for the processor 601, or the communication interface 603 to operate in accordance with various aspects of this disclosure.

The memory 602 may be configured to store, among other things, information 604 representative of CSs available to the radio communication device. As described in various locations in this disclosure, available CSs include possible CSs which other mobile radio communication devices may use to encode payload information to be sent to the radio communication device (e.g. CS1-CS12). In various aspects, the memory 602 may store further information representative of which the available CSs are to be used by which mobile radio communication device of the mobile radio communication devices. In other words, the memory 602 may store candidate CS set for each mobile radio communication device, each candidate CS set including candidate CSs for the respective mobile radio communication device. Referring to the illustrative example of FIG. 5, the memory 602 may store information representing that CS1 and CS7 are candidate CSs for the first MRCD 511, CS2 and CS8 are candidate CSs for the second MRCD 512, and CS3 and CS9 are candidate CSs for the third MRCD 512.

It is to be noted that the radio communication device may have associated according to any known methods with the plurality of mobile radio communication devices. Illustratively, the radio communication device may have established connections with each mobile radio communication device of the plurality of mobile radio communication devices. Within cellular communication context, the established connections may include RRC connections.

The processor 601 may determine a radio signal received from the communication interface. The radio signal may be based on a radio communication signal which is received at determined time and frequency resources for radio communication signal. The time and frequency resources may be for a PUCCH. In some aspects, the radio communication signal may carry payload information of multiple mobile radio communication devices (e.g. of all of the plurality of mobile radio communication devices or a subset of them) which is mapped to a resource block. Each mobile radio communication device may have used one of the CSs previously configured for the respective mobile radio communication device. The radio signal received may be the radio communication signal itself, or a baseband signal (i.e. demodulated version of the received radio communication signal).

In other words, the received radio signal may include payload information of multiple mobile radio communication devices (e.g. MRCD 511 and MRCD 512) mapped to the resource block, and each respective payload information of the payload information encoded by the respective mobile radio communication device may be based on one of CSs configured for (e.g. assigned to) to respective mobile radio communication device. Illustratively, MRCD 511 may have used one of CS1 or CS7 to encode its respective payload information and MRCD 512 may have used one of CS2 or CS8 to encode its respective payload information. Both MRCD 511 and MRCD 512 may have respective uplink radio communication signals carrying respective payload information to the radio communication device at a particular time and frequency resources. Accordingly, the radio signal at the communication interface 603 (corresponding to the received radio communication signal at the particular time and frequency resources) includes payload information including respective payload information of MRCD 511 and MRCD 512.

The processor 601 may decode the received radio signal including respective payload information of multiple mobile radio communication devices, in which each respective payload information is encoded using a corresponding CS. The processor 601 may further perform various operations to manage radio communication operations of the radio communication device, illustratively to obtain the radio signal, such as controlling the communication interface 603 to apply RF demodulation and decoding. In some examples, the processor 601 may obtain a baseband signal from the communication interface 603, and the processor 601 may perform a Fourier Transform (e.g. an FFT) operation on the obtained baseband signal. The processor 601 may further perform de-mapping to obtain the radio signal.

The processor 601 may determine CSs used by the mobile radio communication devices to decode the received radio signal. Illustratively, considering that the received radio signal includes a first cyclically shifted reference sequence (i.e. base sequence) of MRCD 511 and a second cyclically shifted reference sequence of MRCD 512, the processor may determine a first CS applied by MRCD 511 to obtain the first cyclically shifted reference sequence, and a second CS applied by MRCD 512 to obtain the second cyclically shifted reference sequence. A cyclically shifted reference sequence may be described as a reference sequence that is shifted based on one CS of the available CSs. In this illustrative example, the first cyclically shifted reference sequence would include the reference sequence that is shifted by applying either CS1 or CS7. Similarly, the second cyclically shifted reference sequence would include the reference sequence that is shifted by applying either CS2 or CS8.

For this purpose, the processor 601 may, for each mobile radio communication device, determine a candidate CS corresponding to the CS applied by the respective mobile radio communication device. The processor 601 may determine the candidate CS for the respective mobile radio communication device by selecting one candidate CS from the candidate CS set of the respective mobile radio communication device. The processor 601 may determine the candidate CS among all candidate CSs within the candidate CS set of the respective mobile radio communication device based on the received radio signal.

Illustratively, for MRCD 511, the candidate CS set of MRCD 511 includes CS1 and CS7. The processor 601 may determine either CS1 or CS7 as the candidate CS of MRCD 511. Similarly, for MRCD 512, the candidate CS set of MRCD 512 includes CS2 and CS8. The processor 601 may determine either CS2 or CS8 as the candidate CS set of MRCD 512. Similarly, for MRCD 513, the candidate CS set of MRCD 513 includes CS3 and CS9. The processor 601 may determine either CS3 or CS9 as the candidate CS set of MRCD 513. It is to be noted that, at this stage, the processor 601 may be unaware that the radio signal does not include respective payload information of MRCD 513 (i.e. MRCD 513 has not transmitted uplink radio communication signals within the designated time and frequency resources). Ideally, a determined candidate CS for a mobile radio communication device corresponds to the CS that is likely (i.e. most likely, highest probability) applied by that mobile radio communication device to encode the respective payload information.

The processor 601 may perform any known methods to determine candidate CSs for the multiple mobile radio communication devices, such that there is one determined candidate CS for each mobile radio communication device of the multiple radio communication devices. The processor 601 may perform calculations to determine the candidate CSs for the multiple mobile radio communication devices based on the received radio signal.

In accordance with various aspects, the processor 601 may be determine the candidate CSs for the multiple mobile radio communication devices using correlation-based methods. Using such methods, the processor 601 may correlate the received radio signal with multiple reference signals, each reference signal is based on the reference sequence and a candidate CS of all available candidate CSs. Each reference signal may also be described as a cyclically-shifted reference sequence in which a candidate CS of the available candidate CSs is applied. The processor 601 may correlate the received radio signal with a reference signal of the multiple reference signals to obtain a correlation value for the respective reference signal. Based on obtained correlation values, the processor 601 may determine the candidate CS used in the reference signal that has returned the highest correlation value among the multiple reference signals.

In the scenario in which the received radio signal includes payload information of multiple mobile radio communication devices, for each mobile radio communication device of the multiple radio communication devices, the processor 601 may determine correlation values for each candidate CS from the candidate CS set of the respective mobile radio communication device. Accordingly, the processor may determine, for a mobile radio communication device, the candidate CS used in the reference signal that has returned the highest correlation value among multiple reference signals based on candidate CSs within the candidate CS set of the mobile radio communication device.

Illustratively, for MRCD 511, the processor 601 may determine a first correlation value based on a correlation of the received radio signal with a first reference signal, in which CS1 is applied to the reference sequence. The processor 601 may determine a second correlation value based on a correlation of the received radio signal with a second reference signal, in which CS7 is applied to the reference sequence. Based on the first correlation value and the second correlation value, the processor 601 determines one of CS1 or CS7 as the candidate CS for MRCD 511. The processor 601 may perform similar calculations for MRCD 512 with CS2 and CS8, and for MRCD 513 with CS3 and CS9 to determine their respective candidate CSs.

For this purpose, considering all available CSs, the processor 601 may determine a first subset of candidate CSs. The first subset of candidate CSs may include all candidate CSs within candidate CS sets of all the mobile radio communication devices. Illustratively, considering that the mobile radio communication devices include mobile radio communication devices scheduled to use the corresponding time and frequency resources, the first subset includes candidate CS sets of MRCD 511, MRCD 512, MRCD 513, namely {CS1, CS2, CS3, CS7, CS8, CS9} (i.e. candidate CSs assigned to MRCD 511, MRCD 512, MRCD 513). The remaining candidate CSs from all available CSs, namely {CS4, CS5, CS6, CS10, CS11, CS12} may belong to a second subset of candidate CSs, which the processor 601 may also determine. The processor 601 may accordingly determine correlation values based on the candidate CSs within the first subset, and the processor 601 may determine a candidate CS applied by each respective mobile radio communication device based on determined correlation values.

The processor 601 may decode the respective payload information of the respective mobile radio communication devices within the payload information of the received radio signal based on a calculated metric. The calculated metric may be based on a noise power estimation for the received radio signal. The processor 601 may perform the noise power estimation and use estimated noise power values for decoding. The decoding provided in this disclosure includes a determination or an estimation of a CS that has been applied by a mobile radio communication device and based on that determination or estimation, determination of the corresponding information (e.g. UCI, such as HARQ feedback, SR, etc.) received from the respective mobile radio communication device. The processor may decode the respective payload information of the respective mobile radio communication device according to a calculated metric that is based on a noise power value estimated for the respective mobile radio communication device.

In various aspects, the processor 601 may calculate, for each mobile radio communication device, a plurality of correlation power to noise power ratios, each ratio being for one of the candidate CSs, namely a correlation power calculated for the respective candidate CS and a noise power estimate calculated for the respective candidate CS (i.e. using CSs other than the respective candidate CS). The processor 601 may further identify the CS (e.g. a peak CS) that has returned the maximum correlation power to noise power ratio among the candidate CSs for the respective mobile radio communication device.

In communication systems, noise power estimation is pivotal for ensuring reliable signal processing. As transmitted signals travel through the radio communication channel, by encountering noise and interference, noise power estimation is an important aspect for decoding information. Illustratively, the processor 601 may perform this estimation by employing statistical analysis to discern the noise component within the received radio signal. By distinguishing the noise from the signal, the processor 601 may calculate a noise power estimate (e.g. a value). The processor 601 may further use the estimate for further steps in decoding by mitigating the impact of noise and interference, facilitating accurate extraction of information from received radio signals.

In accordance with various aspects provided herein, the processor 601 may perform the noise power estimation by not using the candidate CSs determined as applied by the mobile radio communication devices. The processor 601 may perform the noise power estimation with respect to time and frequency resources using the candidate CSs that are not assigned to any one of the mobile radio communication devices scheduled for transmission using that time and frequency resources. In some aspects, the processor 601 may perform the noise power estimation using candidate CSs from the available candidate CSs, which the candidate CSs are not determined as candidate CSs applied by the mobile radio communication devices.

Considering the above-mentioned explanation using subsets, the noise power estimation may include using candidate CSs of the second subset, considering that candidate CSs that are to be determined as they are applied by the mobile radio communication devices are selected from the first subset. Illustratively and according to previous illustrations, the processor 601 may perform the noise power estimation using candidate CSs from the second subset including {CS4, CS5, CS6, CS10, CS11, CS12}. In various aspects, the noise power estimation may further include using candidate CSs also from the first subset, which are not determined for the mobile radio communication devices. Illustratively, assuming that the processor 601 has determined CS7, CS8, and CS9 from the first subset as the candidate CSs applied to the payload information (i.e. to the respective payloads), the processor 601 may further use CS1, CS2, and CS3 for the noise power estimation, namely define the CSs used for noise power estimation as {CS1, CS2, CS3, CS4, CS5, CS6, CS10, CS11, CS12}. The processor 601 may calculate a noise power estimate for each mobile radio communication device according to these considerations.

The processor 601 may, for each respective payload information of the respective mobile radio communication device, determine a noise power estimate for the respective mobile radio communication device. The processor 601 may further decode the respective payload information based on a calculated metric based on the noise power estimate. The calculated metric may be based on further the noise power estimate for the respective mobile radio communication device and the determined candidate CS for the respective mobile radio communication device. Illustratively, the calculated metric may include a ratio between the correlation value for the determined candidate CS of the respective mobile radio communication device and the noise power estimate for the respective mobile radio communication device. In various examples, the calculated metric described herein may be referred to as a correlation power to noise power ratio, the correlation power being the correlation strength (i.e. correlating a power of the received radio signal with a power of the reference sequence (or reference signal)), or square power of a calculated correlation.

The processor 601 may apply a thresholding based on a thresholding value to decode (and determine) the respective payload information. Illustratively, the processor 601 may determine, for a respective mobile radio communication device, whether the respective mobile radio communication device is in a power-conserving state (e.g. a Discontinuous transmission (DTX) state) in which the respective mobile radio communication device has not sent payload information.

In accordance with various aspects provided herein, the processor 601 may obtain a received signal information representative of a power of the received radio signal. The power of the received radio signal may be a measured power or an estimated power (e.g. a calculated power). In some examples, the processor 601 may estimate or calculate the power of the received radio signal using any known methods. In some examples, the power may be an average power or a mean power.

FIG. 7 shows an exemplary flow diagram to decode respective payload information of multiple mobile radio communication devices in accordance with various aspects provided herein. It is to be considered that candidate CSs that can be used for noise power estimation may include CSs that are not used by any mobile radio communication device (e.g. the second subset as mentioned) and those CSs may be hypothesized as they do not to carry any payload information. Conventionally, for a single mobile radio communication device, hypothesized payload CSs can be tested iteratively (i.e. one by one), and accordingly it is to be recognized that the number of tests will linearly increase with the number of candidate CSs. In this illustrative example, considering the presence of MRCD 511, MRCD 512, and MRCD 513 (i.e. corresponding time and frequency resources are suitable to receive uplink signals from MRCD 511, MRCD 512, and MRCD 513) and configurations indicated each combination of the hypothetical payload CS can be tested across all the mobile radio communication devices.

In this illustrative example, the processor 601 may identify 701 a set of candidate CS tuples as all tuples of candidate CSs. Illustratively, the set of candidate CS tuples includes a tuple for each combination of candidate CSs for the mobile radio communication devices configured to perform uplink transmission within the corresponding time and frequency resources. Illustratively, a tuple within the set include one candidate CS for each mobile radio communication device of the mobile radio communication devices. For example, for MRCD 511, MRCD 512, and MRCD 513, a first tuple may include (CS1, CS2, CS3), a second tuple may include (CS1, CS2, CS9), a third tuple may include (CS7, CS2, CS3), a fourth tuple may include (CS7, CS2, CS9), a fifth tuple may include (CS7, CS8, CS3), a sixth tuple may include (CS7, CS8, CS9), a seventh tuple may include (CS1, CS8, CS3), an eight tuple may include (CS1, CS8, CS9) i.e. by forming the set of candidate CS tuples as combinations including one candidate CS selected from the respective candidate CS set of each mobile radio communication device of the mobile radio communication devices.

In 702, for each tuple in the set of candidate CS tuple, the processor 601 may estimate a noise power by using candidate CSs that are not included in the tuple, and calculate a correlation power to noise power ratio of each mobile radio communication and the respective tuple as a ratio between the correlation power of the CS of the respective mobile radio communication device in the tuple and the estimated noise power.

Illustratively, for each tuple of the identified set of candidate CS tuples, the processor 601 may calculate a correlation value for the respective tuple, the correlation value representative of a similarity between the received radio signal including the cyclically shifted reference sequences of the mobile radio communication devices and a reference sequence that is cyclically shifted with the candidate CSs within the respective tuple. Exemplarily for the first tuple, the reference sequence may include a reference sequence that is shifted using CS1, CS2, and CS3. In some examples, a reference sequence may be shifted for each of candidate CSs and then combined into a combined reference sequence used as the reference sequence for calculation of the correlation.

The processor 601 may accordingly correlate the received radio signal with the reference sequence. In some example, a reference sequence may be shifted for each of candidate CSs, and the processor may calculate a corresponding correlation value for each of candidate CSs, namely by correlating the received radio signal with each of candidate CSs of the tuple, and then combine the correlation values (i.e. partial correlation values) (e.g. sum) to obtain the correlation value. As indicated in various examples, the correlation may be based on powers of the received radio signal and the reference sequences. Furthermore, for each tuple, the processor 601 may perform noise power estimation for the tuple using candidate CSs that are not a member of the respective tuple. Illustratively, for the first tuple, the processor 601 may perform the noise power estimation using CS4, CS5, CS6, CS7, CS8, CS9, CS10, CS11, CS12.

To summarize, the processor 601 has obtained, for each tuple including multiple candidate CSs, each candidate CS being for a corresponding mobile radio communication device of all mobile radio communication devices scheduled for particular time and frequency resources, a correlation power to noise power ratio for each mobile radio communication device. Illustratively, for each tuple of eight tuples provided above, the processor has obtained three correlation power to noise power ratios, each for one of the mobile radio communication devices.

In 703, the processor 601 may make a detection decision on transmit symbols (i.e. of each mobile radio communication device (the respective payload information of the payload information) based on the maximum correlation power to noise power ratio among all candidate CSs of the mobile radio communication device across all tuples. Illustratively, the maximum correlation power to noise power ratio for MRCD 511 is in the first tuple, the maximum correlation power to noise power ratio for MRCD 512, is in the fifth tuple and the maximum correlation power to noise power ratio for MRCD 513 is in the eight tuple. The processor 601 may apply a corresponding thresholding for each maximum correlation power to noise power ratio for a respective MRCD, to make the detection decision. Illustratively, the processor 601 may determine that MRCD 513 is within a DTX state (i.e. maximum correlation to noise power ratio for MRCD 513 is below a threshold), and the processor 601 may decode the payload information of MRCD 511 and the payload information of MRCD 512 accordingly.

In various examples, the above-mentioned procedure described in accordance with FIG. 7 may allow the processor 601 to determine candidate CSs for each mobile radio communication device from respective candidate CS sets of respective mobile radio communication device. Accordingly, the processor 601 may calculate noise power estimates for each combination within the plurality of combinations (e.g. each tuple within the set of candidate CS tuples). Based on obtained correlation power to noise power ratios for each mobile radio communication within all tuples, the processor 601 may decode respective payload information of each mobile radio communication device. The decoding may include determination of whether the respective mobile radio communication device has set payload information or whether the respective mobile radio communication device is within a power-conserving mode (e.g. a DTX mode). Further, it is to be recognized that the performed noise power estimations include using the candidate CSs of the second subset, and further candidate CSs that are within the first subset but that are not within the combination provided by the respective tuple.

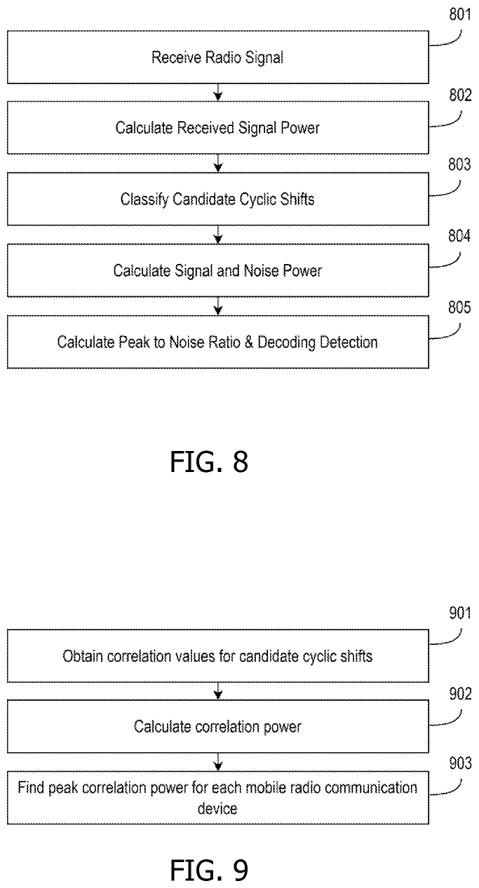

FIG. 8 shows an exemplary flow diagram to decode the respective payload information of multiple mobile radio communication devices in accordance with various aspects provided in this disclosure. In comparison with the decoding described in accordance with FIG. 7, the aspects described herein allow the radio communication device to employ increased amount of CSs for radio communication reliably and adapt dynamic changes in noise and interference efficiently by reducing the complexity of the calculations to provide functions for decoding the received radio signal. This flow diagram is to be illustrated in accordance with the aspects and examples described in accordance with FIGS. 5 and 7 with respect to the presence of MRCD 511, MRCD 512, and MRCD 513 (i.e. corresponding time and frequency resources are suitable to receive uplink signals from MRCD 511, MRCD 512, and MRCD 513).

In 801, the processor 601 may receive radio signal and perform FFT processing and de-mapping to obtain data symbols. Further, the processor 601 may calculate 802 received signal power for the received radio signal based on the obtained data symbols. The calculated received signal power may be an average power. The processor 601 may analyze magnitude of received data symbols, by taking magnitudes of each received symbol, square the magnitude, and average squared values over a period of time.

Illustratively, considering MIMO communication, the processor 601 may calculate received signal power (RP) in accordance with the mathematical formula below, received power being representative of a received power at receive antenna “r” and per symbol “1”, K being number of subcarriers (e.g. 12), k denoting a subcarrier index, Y denoting the received radio signal (e.g. baseband signal):

$$R P ( r , l ) = \frac{1}{K} {\sum }_{k = 0 … 11} {\vert Y ( k , l , r ) \vert}^{2}$$

In parallel, the received antenna signal power (RAP) per antenna may represent the average received power across the OFDM symbols (L), which may be denoted as the below,

$$RAP ( r ) = \frac{1}{L} {\sum }_{l = 0 … L - 1} R P ( r , l )$$

In various aspects, in which the frequency hopping is enabled for the time and frequency resources, the processor 601 may use the RP. If the frequency hopping is disabled for the time and frequency resources, the processor 601 may use the RAP.

Furthermore, the processor 601 may classify 803 candidate CSs of the available candidate CSs. The classifying may include determining one candidate CS for each mobile radio communication device from the available candidate CSs. The processor 601 may employ any one of the aspects described herein to identify candidate CSs for decoding. The classifying may further include calculating correlation values for the candidate CS of the mobile radio communication devices. Furthermore, the processor 601 may determine candidate CSs that are to be used to perform noise power estimations. Such aspects are particularly described in accordance with FIGS. 5-7. As described above, the processor 601 may determine the first subset from the available candidate CSs including candidate CSs assigned to the mobile radio communication devices, illustratively MRCD 511, MRCD 512, MRCD 513. Furthermore, the processor 601 may determine the second subset from the available candidate CSs.

In more detail, assuming that there is a plurality of available candidate CSs, including illustratively 12 CSs for the time and frequency resources scheduled for MRCD 511, MRCD 512, and MRCD 513, the plurality of available CSs may be denoted as:

S={S_{H},S_{NULL}}

In this notation, S_{H} denotes the first subset of the set S, the first subset including candidate CSs of the set S, which are assigned to the mobile radio communication devices scheduled for the time and frequency resources (e.g. PUCCH resources). S_{NULL} denotes the second subset of the set S, the second subset including candidate CSs of the set S, which are not assigned to the mobile radio communication devices. Illustratively, considering CSs of MRCD 511, MRCD 512, and MRCD 513, S_{H}={CS1, CS2, CS3, CS7, CS8, CS9} and S_{NULL}={CS4, CS5, CS6, CS10, CS11, CS12}. Further, S_{H} may be formulated to denote CSs that each mobile radio communication device is configured to use (e.g. assigned or configured by radio communication device), u being an index for mobile radio communication devices:

$${S}_{H} = {⋃}_{u = 0}^{U - 1} {S}_{u , H}$$

It is to be noted that possible sequences used by a mobile radio communication device may be based on the payload information and initial CS for that mobile radio communication device. S may have been referred to as available candidate CSs and S_{H} may have been referred to candidate CSs for (or of) the corresponding mobile radio communication devices (e.g. allowed to use the time and frequency resources) including candidate CS sets of the corresponding mobile radio communication devices.

FIG. 9 shows an exemplary flow diagram illustrating some aspects that the processor 601 may perform for classifying 803 the candidate CSs. In various aspects provided herein, the processor 601 may obtain 901 correlation values for candidate CSs. For example, the processor 601 may calculate a correlation value for each CS from the set S_{H}. It is to be noted that, S_{NULL} may include candidate CSs that the processor 601 may perform noise power estimations. In some aspects, in which calculated correlation values include correlation power, the processor 601 may further calculate 902 correlation powers corresponding to each calculated correlation value.

For example, the processor may calculate the correlation values for the candidate CSs according to the mathematical equation described below, in which Cᵢ(u, r, l) denotes the correlation value for CS i, symbol 1 and received antenna r for UE u, Xᵢ(k, l) denotes a cyclically shifted reference sequence at subcarrier k, and symbol 1 that is shifted with the candidate CS having the index i, Y(k, l, r) denoting received radio signal (e.g. baseband signal), K being number of subcarriers (e.g. 12), H being the Hermitian operator; noting that CS index i∈S_{u,H}:

$${C}_{i} ( u , r , l ) = \frac{1}{K} {\sum }_{k = 0 … 11} Y ( k , l , r ) {{X}_{i} ( k , l )}^{H}$$

In accordance with various aspects provided herein, the processor 601 may calculate 902 the correlation powers in accordance with above-formulated correlation values. As indicated, a correlation power may refer to a power calculated from the correlation values (e.g. squared power of a corresponding correlation value). In various aspects, in which the frequency hopping is not supported, given that the processor 601 processes adjacent symbols within the same slot and the channel across OFDM symbols is assumed to be the same for the same antenna, the processor 601 may calculate the correlation power Pᵢ(u, r), denoting correlation power for CS i at received antenna r for the mobile radio communication device u, as the following:

$${P}_{i} ( u , r ) = {\vert \frac{1}{L} {\sum }_{l = 0 … i - 1} {C}_{i} ( u , r , l ) \vert}^{2} , i ∈ {S}_{u , H}$$

P̅ᵢ(u)=Σ_{r=0 . . . N-1} Pᵢ(u, r) Accordingly, for multiple radio communication devices, the processor 601 may calculate a cumulative correlation power of a CS may be formulated by summing the correlation power received at each antenna for all antennas, according to:

In various aspects, in which the frequency hopping is supported, given that the processor 601 processes adjacent symbols within the same slot and the channel across OFDM symbols is assumed to be the same for the same antenna, the processor 601 may calculate the correlation power Pᵢ(u, r), denoting correlation power for CS i at received antenna r and symbol 1 or the mobile radio communication device u, as the following:

$${P}_{i} ( u , r , l ) = {\vert {C}_{i} ( u , r , l ) \vert}^{2} , i ∈ {S}_{u , H}$$

P̅ᵢ(u)=Σ_{r=0 . . . . N-1} Σ_{l=0 . . . L-1} Pᵢ(u, r, l) Accordingly, for multiple radio communication devices, the processor 601 may calculate a cumulative correlation power of a CS may be formulated by summing the correlation power received at each antenna for all antennas, according to:

After calculation of the correlation values, the processor 601 may find 903 and select, for each mobile radio communication device, one of the CSs from S_{u,H} of the respective mobile radio communication device, which has returned a peak-correlation value (e.g. a peak correlation power). In other words, with an intention of getting more accurate noise power estimation, the CS from the set S_{u,H} for each mobile radio communication device u that achieves peak correlation power is termed as the candidate CS determined for that mobile radio communication device, and is denoted as cs_{u,max}. This can be formulated as cs_{u,max}=max_{i∈S}_{_{u,H}}(P̅ᵢ(u)).

In some aspects, each CS that achieves peak correlation power (e.g. c_{su,max}) for a respective mobile radio communication device may be referred to as a peak correlation CS for the respective mobile radio communication device. Accordingly, the processor 601 may determine, for each mobile radio communication device, a peak correlation CS. The peak correlation power may refer to the power of the correlation value (e.g. squared power) calculated for the peak correlation CS for the respective radio communication device.

After the above-mentioned determination of the candidate CS, the set S may be considered, considering that S_{NULL} stays unchanged, while S_{H} (i.e. the first subset) is segmented into two further subsets, namely an Sₘₐₓ representative of the candidate CSs determined for the mobile radio communication devices (i.e. the CSs cs_{u,max} that achieve peak correlation power for the respective (index=u) mobile radio communication devices), and an Sₙₒₙ₋ₘₐₓ representative of remaining candidate CSs from each candidate CS set of the respective mobile radio communication devices. In other words, Sₘₐₓ={cs_{0,max}, cs_{1,max}> . . . . CS_{U-1,max}} may be the collection of peak CSs of the mobile radio communication devices configured to communicate using the time and frequency responses, Sₙₒₙ₋ₘₐₓ=S_{H} \Sₘₐₓ is the set of non-peak CS of the mobile radio communication devices, and S_{Null} contains unoccupied CSs. It is to be noted that various aspects of this disclosure, include that the processor 601 may perform noise-power estimation using the CSs contained in Sₙₒₙ₋ₘₐₓ and S_{NULL}.

Illustratively, assuming that CS1, CS2, CS3 have returned corresponding maximum correlation values (peak correlation power) for MRCD 511, MRCD 512, and MRCD 513 respectively, Sₙₒₙ₋ₘₐₓ={CS7, CS8, CS9} and Sₘₐₓ={CS1, CS2, CS3}. Illustratively, CS1 is the peak correlation CS for MRCD 511; CS2 is the peak correlation CS for MRCD 512, and CS3 is the peak correlation CS. It is to be noted that there is a corresponding peak correlation value (e.g. peak correlation power) for each CS1, CS2, and CS3 for MRCD 511, MRCD 512, and MRCD 513 respectively.

Furthermore, the processor 601 may calculate 804 signal and noise power for each mobile radio communication device. In accordance with various aspects provided herein, the processor 601 may calculate a noise power estimate based on candidate CSs from the available candidate CSs, which are not peak correlation CSs. In other words, the processor 601 may calculate noise power estimates for candidate CSs within Sₙₒₙ₋ₘₐₓ and S_{NULL}.

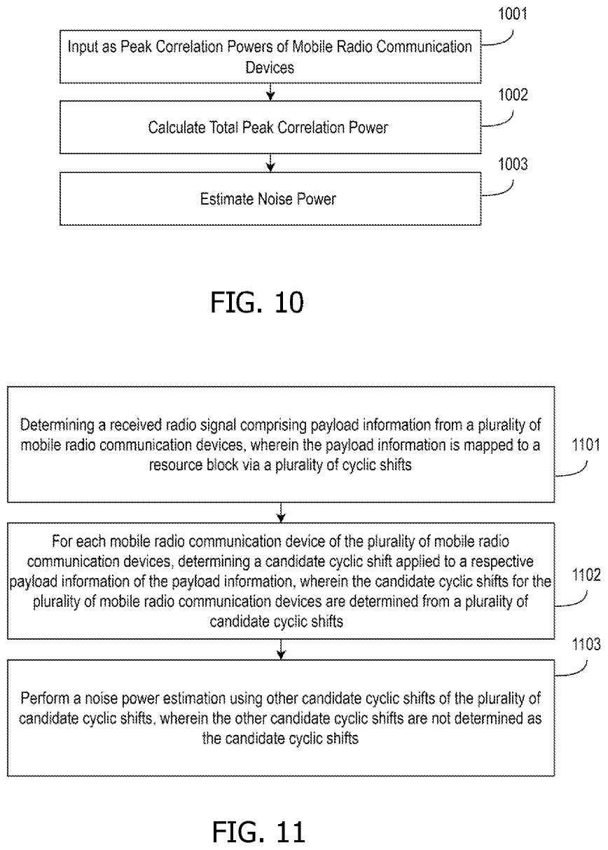

FIG. 10 shows an exemplary flow diagram illustrating some aspects that the processor 601 may perform to calculate 804 signal and noise power. It is to be noted that Pᵢ(u, r) and Pᵢ(u, r, l) may have been calculated by the processor 601 in 803 for all candidate CSs within S_{H}. Now, the processor 601 may receive 1001—only—calculated correlation powers for the peak CSs, namely CSs within Sₘₐₓ. In accordance with the notations used herein, these correlation powers may be denoted as P_{cs}_{_{u,max}} (u, r) or P_{cs}_{_{u,max}} (u, r, l) depending on the support of the frequency hopping as indicated above.

The processor 601 may further calculate 1002 a total peak correlation power. The total peak correlation power may represent the sum of the peak correlation power (maximum correlation power) of the mobile radio communication devices that are configured to communicate using the time and frequency resources. Based on the support of the frequency hopping, the total peak correlation power (TPCP) may be formulated per receive antenna as one of the:

$$TPCP ( r ) = {\sum }_{u = 0 … U - 1} {P}_{{cs}_{u , m ax}} ( u , r ) or$$

$$TPCP ( r , l ) = {\sum }_{u = 0 … U - 1} {P}_{{cs}_{u , m ax}} ( u , r , l )$$

Accordingly, the processor 601 may calculate 1003 a power noise estimate, i.e. a common noise power. The processor 601 may calculate the power noise estimate based on the TPCP and the power of the received signal. Based on the support of the frequency hopping, the processor 601 may calculate the noise power estimate as one of the following:

$$N ( r ) = \frac{1}{( 12 - U )} ( R A P ( r ) - T P C P ( r ) ) or$$

$$N ( r , l ) = \frac{1}{( 12 - U )} ( R P ( r , l ) - T P C P ( r , l ) ) .$$

The processor 601 may accordingly calculate 805 corresponding metrics for the mobile radio communication device to decode respective payload information of the respective mobile radio communication devices. Each metric may include a correlation peak power to noise ratio for the respective mobile radio communication device. For this purpose, the processor 601 may further determine whether the radio communication device is configured for a common noise power across all antennas or not. In some aspects, the processor 601 may check the parameter PFO_CommonNoiseVarForAllRxAnt to determine for this configuration. It is to be noted that Pᵢ(u, r) and Pᵢ(u, r, l) may have been calculated by the processor 601 in 803 for all candidate CSs within S_{H}.

For example, if there is a common noise power across all antennas configuration, the processor 601 may average the noise power estimate and the correlation power, exemplarily for a configuration in which the frequency hopping is not supported:

$${Avg\_P}_{i} ( u ) = \frac{1}{R} {\sum }_{r = 0 … N - 1} {P}_{i} ( u , r )$$

$$Avg\_N = \frac{1}{R} {\sum }_{r = 0 … N - 1} N ( r )$$

For example, if there is a common noise power across all antennas configuration, the processor 601 may average the noise power estimate and the correlation power, exemplarily for a configuration in which the frequency hopping is supported:

$${Avg\_P}_{i} ( u ) = \frac{1}{R \times L} {\sum }_{r = 0 … N - 1} {\sum }_{l = 0 … L - 1} {P}_{i} ( u , r , l )$$

$$Avg\_N = \frac{1}{R \times L} {\sum }_{r = 0 … N - 1} {\sum }_{l = 0 … L - 1} N ( r , l )$$

In both notations, Avg_Pᵢ(u) is averaged correlation power for mobile radio communication device u and CS index i E S_{u,H} and Avg_N is averaged common noise power used in multi-mobile radio communication device scenario. Accordingly, NR for hypothesis i PNRᵢ(u) for mobile radio communication device u is given by:

$$P N {R}_{i} ( u ) = \frac{{Avg\_P}_{i} ( u )}{Avg\_N}$$

Alternatively, if there is not a common noise power across all antennas configuration, the processor 601 may average the noise power estimate and the correlation power, exemplarily for a configuration in which the frequency hopping is supported, in which PNR for hypothesis i per antenna per OFDM symbol (PNRᵢ(r, l)) is given by:

$$P N {R}_{i} ( u , r , l ) = \frac{{P}_{i} ( u , r , l )}{N ( r , l )}$$

And, PNR for hypothesis i (PNRᵢ) being the average of PNRᵢ(u, r, l) across antennas and OFDM symbol:

$$P N {R}_{i} ( u ) = \frac{1}{R \times L} {\sum }_{r = 0 … N - 1} {\sum }_{l = 0 … L - 1} P N {R}_{i} ( u , r , l )$$

Accordingly, the processor 601 may determine the sequence giving the highest PNR as the CS used by respective mobile radio communication device u as:

$$P N {R}_{i \_ m ax} ( u ) = max \{ P N {R}_{i} ( u ) \vert i ∈ {S}_{u , H} \}$$

Further, the processor 601 may apply a thresholding to the PNR_{i_max}(u) for DTX detection. The processor 601 may, based on a threshold, apply the thresholding. The threshold may include a predetermined or a predefined threshold. Illustratively, if PNR_{i_max} for the mobile radio communication device u is greater than the threshold, the processor 601 may determine that there is respective payload information of the mobile radio communication device u. Furthermore, based on the candidate CS determined for the mobile radio communication device u, namely the candidate CS having the maximum PNR among candidate CSs of the mobile radio communication device u, the processor 601 may determine the corresponding symbol as the payload information. Illustratively, the processor 601 may determine whether the payload information includes an HARQ acknowledgement signal, and/or whether the payload information includes a scheduling request. On the other hand, if the PNR_{i_max} for the mobile radio communication device u is not greater than the threshold, the processor 601 may determine that the mobile radio communication device u is within a power conserving (e.g. DTX) state. It is to be noted that the DTX threshold is a statistical value derived via representative simulations with different SNR range and tuned to guarantee best performance accordingly to 3GPP test requirements.

It is to be noted that, although the flow diagram described in FIG. 7 and the flow diagram described in FIG. 8 seem to address similar techniques, the skilled person would recognize that many aspects are combinable. In fact, the processor 601 be configured to iteratively use the aspects described in FIG. 8. For example, the processor 601 may initially perform detection determinations for the respective payload information of the mobile radio communication devices in accordance with the aspects described with respect to FIG. 7.

Furthermore, the processor 601 may recalculate noise power estimates using the candidate CSs from the available candidate CSs, which are not determined as the candidate CSs for the respective mobile radio communication devices (i.e. Sₙₒₙ₋ₘₐₓ and S_{NULL}). If the processor 601 determines that the difference between the recalculated noise power estimates and previously calculated noise power estimates in accordance with the aspects described within FIG. 7 is above a predefined threshold, the processor 601 may perform aspects described within FIG. 8 by computing a ratio between the maximum correlation power and noise power estimate. Accordingly, the processor 601 may perform a decoding decision for the respective payload information based on the peak CS and the value of the ratio. If the decoding decision is different from the previous iteration, the processor 601 may again recalculate noise power estimates and follow the previous steps.

Moreover, certain simulation results are described below in a scenario, in which the mobile radio communication devices are simulated as UEs, and the radio communication device is simulated as a BS that perform PUCCH Format 0 decoding using the aspects described in this disclosure.

Simulation 1 (5 UE)
Subcarrier Spacing - 30 KHz
Channel Bandwidth - 100 MHz
#Antenna - 4, #Symbols - 2 (with Frequency Hopping), Payload - 1 Bit UCI
Channel Model - Scenario: TDL-A, Delay Scaling: 30 ns, Max Doppler Freq: 10 Hz
#Slots - 10000

| | | | | | isDtxMode = false | |
|---|---|---|---|---|---|---|
| | | isDtxMode = true | | | ACK missed | ACK missed |
| | | DTX to ACK | DTX to ACK | | detection | detection |
| | | probability | probability | | probability | probability |
| | | (Conventional | (Proposed | | (Conventional | (Proposed |
| Threshold | UE# | Method) | Solution) | SNR | Method) | Solution) |
| | | Seed Type = Fixed | | | | |
| 5.48 | 1 | 0.0044 | 0.0032 | −2 | 0.0129 | 0.0095 |
| | 2 | 0.0039 | 0.0031 | | 0.0165 | 0.0134 |
| | 3 | 0.0029 | 0.0039 | | 0.0097 | 0.0074 |
| | 4 | 0.004 | 0.0022 | | 0.0071 | 0.0052 |
| | 5 | 0.0038 | 0.0031 | | 0.0079 | 0.0059 |
| | 1 | | | −1 | 0.0033 | 0.0027 |
| | 2 | | | | 0.0074 | 0.0062 |
| | 3 | | | | 0.0027 | 0.0024 |
| | 4 | | | | 0.0017 | 0.0012 |
| | 5 | | | | 0.0022 | 0.0016 |
| | 1 | | | −0.8 | 0.0027 | 0.0018 |
| | 2 | | | | 0.0057 | 0.0052 |
| | 3 | | | | 0.0021 | 0.002 |
| | 4 | | | | 0.0012 | 0.0007 |
| | 5 | | | | 0.0016 | 0.0013 |
| | | Seed Type = Random | | | | |
| 5.48 | 1 | 0.0052 | 0.0035 | −2 | 0.012 | 0.01 |
| | 2 | 0.0034 | 0.004 | | 0.0163 | 0.0106 |
| | 3 | 0.0035 | 0.0038 | | 0.0109 | 0.01 |
| | 4 | 0.0046 | 0.0029 | | 0.0139 | 0.0052 |
| | 5 | 0.0034 | 0.0032 | | 0.0133 | 0.0082 |
| | 1 | | | −1 | 0.0046 | 0.0011 |
| | 2 | | | | 0.0065 | 0.0033 |
| | 3 | | | | 0.0037 | 0.0005 |
| | 4 | | | | 0.0033 | 0.0015 |
| | 5 | | | | 0.0046 | 0.0065 |
| | 1 | | | −0.8 | 0.0038 | 0.001 |
| | 2 | | | | 0.0038 | 0.0019 |
| | 3 | | | | 0.0017 | 0.0015 |
| | 4 | | | | 0.0024 | 0.0016 |
| | 5 | | | | 0.0035 | 0.0019 |

Simulation 2 (6 UE)
Subcarrier Spacing - 30 KHz
Channel Bandwidth - 100 MHz
#Antenna - 4, #Symbols - 1, Payload - 1 Bit UCI
Channel Model - Scenario: TDL-A, Delay Scaling: 30 ns, Max Doppler Freq: 10 Hz
#Slots - 10000

| | | | | | isDtxMode = false | |
|---|---|---|---|---|---|---|
| | | isDtxMode = true | | | ACK missed | ACK missed |
| | | DTX to ACK | DTX to ACK | | detection | detection |
| | | probability | probability | | probability | probability |
| | | (Conventional | (Proposed | | (Conventional | (Proposed |
| Threshold | UE# | Method) | Solution) | SNR | Method) | Solution) |
| | | Seed Type = Fixed | | | | |
| 4 | 1 | | 0.0062 | 1 | 0.1661 | 0.0265 |
| | 2 | | 0.0062 | | 0.1525 | 0.0299 |
| | 3 | | 0.0047 | | 0.1491 | 0.0283 |
| | 4 | | 0.006 | | 0.1114 | 0.013 |
| | 5 | | 0.0062 | | 0.0959 | 0.0109 |
| | 6 | | 0.0068 | | 0.1427 | 0.0199 |
| 7 | 1 | 0.0072 | | 2 | 0.1035 | 0.0138 |
| | 2 | 0.006 | | | 0.1013 | 0.0151 |
| | 3 | 0.0066 | | | 0.0911 | 0.0158 |
| | 4 | 0.0068 | | | 0.0619 | 0.0055 |
| | 5 | 0.0072 | | | 0.0549 | 0.0051 |
| | 6 | 0.0066 | | | 0.083 | 0.0089 |
| | 1 | | | 3.3 | 0.049 | 0.005 |
| | 2 | | | | 0.0478 | 0.0067 |
| | 3 | | | | 0.0478 | 0.0073 |
| | 4 | | | | 0.0265 | 0.0011 |
| | 5 | | | | 0.0232 | 0.0015 |
| | 6 | | | | 0.0366 | 0.0034 |
| | | Seed Type = Random | | | | |
| 4 | 1 | | 0.006 | 1 | 0.1381 | 0.03 |
| | 2 | | 0.0064 | | 0.1155 | 0.0299 |
| | 3 | | 0.0061 | | 0.1546 | 0.0164 |
| | 4 | | 0.0069 | | 0.1172 | 0.0173 |
| | 5 | | 0.0071 | | 0.1255 | 0.0197 |
| | 6 | | 0.0056 | | 0.1143 | 0.0263 |
| 7 | 1 | 0.0058 | | 2 | 0.0606 | 0.0104 |
| | 2 | 0.007 | | | 0.0812 | 0.0127 |
| | 3 | 0.0069 | | | 0.0751 | 0.0128 |
| | 4 | 0.0062 | | | 0.0829 | 0.006 |
| | 5 | 0.0054 | | | 0.056 | 0.0076 |
| | 6 | 0.0067 | | | 0.0765 | 0.0108 |
| | 1 | | | 3.3 | 0.0382 | 0.0033 |
| | 2 | | | | 0.0387 | 0.0028 |
| | 3 | | | | 0.0342 | 0.0103 |
| | 4 | | | | 0.0247 | 0.0003 |
| | 5 | | | | 0.04 | 0.0042 |
| | 6 | | | | 0.0384 | 0.0037 |

It is to be noted that, Simulation 1: For the same threshold and SNR level, the proposed solution gives better performance results compared to conventional method.

Simulation 2: For the same SNR level, proposed solution gives better performance results even at a lower threshold compared to conventional method.

Accordingly, it may be concluded that with a multiple user scenario, the aspects described herein seems to show better performance for both DTX to ACK and ACK missed detection probability criteria. The performance improvement can be most seen when the #CSs are exhausted (like in a 6 UE, 1 Bit UCI case).

FIG. 11 shows an example of a method. The method that may include: determining 1101 a received radio signal comprising payload information from a plurality of mobile radio communication devices, wherein the payload information is mapped to a resource block via a plurality of cyclic shifts; for each mobile radio communication device of the plurality of mobile radio communication devices, determining 1102 candidate cyclic shift applied to a respective payload information of the payload information, wherein the candidate cyclic shifts for the plurality of mobile radio communication devices are determined from a plurality of candidate cyclic shifts; and performing 1103 a noise power estimation using other candidate cyclic shifts of the plurality of candidate cyclic shifts, wherein the other candidate cyclic shifts are not determined as the candidate cyclic shifts. Exemplarily, a non-transitory computer-readable medium may include instructions which, if executed by a processor, cause the processor to perform the method.

The following examples pertain to further aspects of this disclosure.

In example 1, the subject matter includes a radio communication device including: a memory; and a processor configured to: determine a received radio signal including payload information from a plurality of mobile radio communication devices, wherein the payload information is mapped to a resource block via a plurality of cyclic shifts; for each mobile radio communication device of the plurality of mobile radio communication devices, determine a candidate cyclic shift applied to a respective payload information of the payload information, wherein the candidate cyclic shifts for the plurality of mobile radio communication devices are determined from a plurality of candidate cyclic shifts; and perform a noise power estimation using other candidate cyclic shifts of the plurality of candidate cyclic shifts, wherein the other candidate cyclic shifts are not determined as the candidate cyclic shifts.

In example 2, the subject matter of example 1, wherein the processor is further configured to determine a noise power based on the other candidate cyclic shifts; wherein the processor is further configured to decode the respective payload information based on a calculated metric based on the noise power.

In example 3, the subject matter of example 2, wherein the processor is further configured to decode the respective payload information based on the candidate cyclic shift for the respective mobile radio communication device and the noise power.

In example 4, the subject matter of example 3, wherein the processor is further configured to determine a first subset of potential cyclic shifts from the plurality of candidate cyclic shifts and a second subset of potential cyclic shifts from the plurality of candidate cyclic shifts; wherein the first subset of potential cyclic shifts including the candidate cyclic shifts.

In example 5, the subject matter of example 4, wherein the first subset of potential cyclic shifts includes predetermined candidate cyclic shifts from the plurality of candidate cyclic shifts.

In example 6, the subject matter of example 4 or example 5, wherein the first subset of potential cyclic shifts includes the candidate cyclic shifts assigned to the plurality of mobile radio communication devices.

In example 7, the subject matter of any one of examples 4 to 6, wherein the processor is further configured to determine a correlation value for each potential cyclic shift of the first subset of potential cyclic shifts; wherein the processor is further configured to perform the noise power estimation using the second subset of potential cyclic shifts.

In example 8, the subject matter of example 7, wherein the processor is further configured to determine, for each mobile radio communication device of the plurality of radio communication devices, the candidate cyclic shift applied to the respective payload information based on the correlation values.

In example 9, the subject matter of example 8, wherein, for each mobile radio communication device, a peak correlation cyclic shift is determined, the peak correlation cyclic shift being one of the candidate cyclic shifts from the first subset having the maximum correlation power value for the respective mobile radio communication device among the candidate cyclic shifts for the respective mobile radio communication device; wherein a peak correlation power is a power of the correlation value calculated for the peak correlation cyclic shift for the respective mobile radio communication device.

In example 10, the subject matter of claim 8 or claim 9, wherein the other candidate cyclic shifts comprise the second subset of potential cyclic shifts and other potential cyclic shifts of the first subset of potential cyclic shifts that are not determined as the peak correlation cyclic shifts.

In example 11, the subject matter of any one of claims 7 to 11, wherein the processor is configured to calculate a correlation power for each radio communication device, the correlation power is representative of a power of correlation between the received radio signal and a cyclically shifted reference sequence; wherein the processor is further configured to combine the correlation power for the plurality of radio communication devices from a plurality of receive antennas and OFDM symbols to obtain a combined correlation power; wherein the processor is further configured to identify the peak correlation cyclic shift is the cyclic shift having the maximum combined correlation power value for the respective mobile radio communication device among assigned candidate cyclic shifts of the respective mobile radio communication device.

In example 12, the subject matter of any one of claims 7 to 11, wherein the processor is further configured to calculate a total peak correlation power, wherein the total peak correlation power is representative of the sum of the peak correlation power of mobile radio communication devices.; wherein the noise power is based on a calculated signal power of the received radio signal and the total peak correlation power.

In example 13, the subject matter of example 12, wherein the processor is further configured to calculate the noise power based on a difference of the calculated signal power and the total peak correlation power for each of the plurality of receive antennas and OFDM symbols.

In example 14, the subject matter of example 12 or example 13, wherein the processor is further configured to decode the respective payload information based on the calculated metric that is based on the noise power and the correlation power for the respective mobile radio communication device.

In example 15, the subject matter of any one of claims 1 to 8, wherein the processor is further configured to determine a plurality of candidate cyclic shift combinations, each combination of the plurality of candidate cyclic shift combinations including first candidate cyclic shifts from different mobile radio communication devices.

In example 16, the subject matter of example 15, wherein the processor is further configured to select one of the plurality of candidate cyclic shift combinations based on calculated metrics for each combination of the plurality of combinations; wherein the first candidate cyclic shifts of the selected one of the plurality of candidate cyclic shift combinations define the candidate cyclic shifts for the plurality of mobile radio communication devices.

In example 17, the subject matter of example 15 or example 16, wherein the processor is further configured to calculate a plurality of correlation values for each combination, each correlation value being based on the first candidate cyclic shifts of the respective combination; wherein each calculated correlation is representative of a similarity between a received radio signal and a reference sequence obtained based on a respective cyclic shift of the first candidate cyclic shifts.

In example 18, the subject matter of example 17, wherein the processor is configured to calculate the correlation value of each respective combination based on the received radio signal and the reference sequence.

In example 19, the subject matter of example 18, wherein the processor is further configured to calculate, for each combination, a plurality of first candidate correlation values, each first candidate correlation value is based on one of the first candidate cyclic shifts.

In example 20, the subject matter of example 19, wherein the processor is further configured to estimate a noise power for each combination, each estimated noise power is based on second candidate cyclic shifts of the plurality of cyclic shifts and the first candidate cyclic shifts, wherein the second candidate cyclic shifts different from the first cyclic shifts.

In example 21, the subject matter of example 20, wherein the calculated metric for each candidate cyclic shift of the first candidate cyclic shifts and each combination is based on the respective correlation value and the noise power of the respective combination.

In example 22, the subject matter of example 21, wherein the calculated metric for each candidate cyclic shift of the first candidate cyclic shifts and each combination is a first cyclic shift and combination ratio of the power of respective correlation value to the noise power of the respective combination; wherein the processor is configured to select a candidate cyclic shift ratio as the highest first cyclic shift and combination ratio achieved with the candidate cyclic shift among the plurality of candidate cyclic shift combinations containing the candidate cyclic shift as the first candidate cyclic shifts; wherein the processor is configured to select a ratio for a mobile radio communication device as having the highest ratio among the plurality of the candidate cyclic shifts of the mobile radio communication device.

In example 23, the subject matter of example 22, wherein the processor is further configured to decode the payload information based on the selected ratio of the mobile radio communication device.

In example 24, the subject matter of any one of claims 2 to 23, wherein the processor is further configured to determine whether the respective payload includes a symbol transmitted by the respective radio communication device based on a threshold applied to the calculated metric.

In example 25, the subject matter of example 24, wherein the processor is further configured to determine whether there is a discontinuous transmission for the respective radio communication device based on the threshold applied to the calculated metric.

In example 26, the subject matter of any one of claims 1 to 25, may further include a radio frequency interface configured to receive radio signals from one or more antennas.

In example 27, the subject matter of example 26, may further include a radio frequency circuit coupled to the radio frequency interface, the radio frequency circuit is connectable to the one or more antennas.

In example 28, the subject matter of any one of claims 1 to 27, wherein the received radio signal is a physical uplink control channel signal.

In example 29, the subject matter of example 28, wherein the respective payload information includes an uplink control information.

In example 30, a radio communication device, including: a memory; and a processor configured to: determine a received radio signal including payload information from a plurality of mobile radio communication devices, wherein the payload information is mapped to a resource block via applied cyclic shifts of a plurality of cyclic shifts; identify a first cyclic shifts from the plurality of cyclic shifts; correlate the received radio signal with cyclically shifted reference sequences that are shifted using the first set of candidate cyclic shifts; perform a noise power estimation based on second cyclic shifts of the plurality of cyclic shifts, wherein the second cyclic shifts are different from the first cyclic shifts.

In example 31, The radio communication device of example 30, wherein the radio communication device is further configured to perform any other aspects described herein, in particular aspects described in any one of examples 2 to example 29.

In example 32, the subject matter includes a non-transitory computer-readable medium including instructions which, if executed by a processor, cause the processor to: determine a received radio signal including payload information from a plurality of mobile radio communication devices, wherein the payload information is mapped to a resource block via a plurality of cyclic shifts; for each mobile radio communication device of the plurality of mobile radio communication devices, determine a candidate cyclic shift applied to a respective payload information of the payload information, wherein the candidate cyclic shifts for the plurality of mobile radio communication devices are determined from a plurality of candidate cyclic shifts; and perform a noise power estimation using other candidate cyclic shifts of the plurality of candidate cyclic shifts, wherein the other candidate cyclic shifts are not determined as the candidate cyclic shifts.

In example 33, the subject matter of example 32, wherein the instructions further cause the processor to determine a noise power based on the other candidate cyclic shifts; and decode the respective payload information based on a calculated metric based on the noise power.

In example 34, the subject matter of example 33, wherein the instructions further cause the processor to decode the respective payload information based on the candidate cyclic shift for the respective mobile radio communication device and the noise power.

In example 35, the subject matter of example 34, wherein the instructions further cause the processor to determine a first subset of potential cyclic shifts from the plurality of candidate cyclic shifts and a second subset of potential cyclic shifts from the plurality of candidate cyclic shifts; wherein the first subset of potential cyclic shifts including the candidate cyclic shifts.

In example 36, the subject matter of example 35, wherein the first subset of potential cyclic shifts includes predetermined candidate cyclic shifts from the plurality of candidate cyclic shifts.

In example 37, the subject matter of example 35 or example 36, wherein the first subset of potential cyclic shifts includes the candidate cyclic shifts assigned to the plurality of mobile radio communication devices.

In example 38, the subject matter of any one of examples 35 to 37, wherein the instructions further cause the processor to determine a correlation value for each potential cyclic shift of the first subset of potential cyclic shifts; and perform the noise power estimation using the second subset of potential cyclic shifts.

In example 39, the subject matter of example 38, wherein the instructions further cause the processor to determine, for each mobile radio communication device of the plurality of radio communication devices, the candidate cyclic shift applied to the respective payload information based on the correlation values.

In example 40, the subject matter of example 39, wherein, for each mobile radio communication device, a peak correlation cyclic shift is determined, the peak correlation cyclic shift being one of the candidate cyclic shifts from the first subset having the maximum correlation power value for the respective mobile radio communication device among the candidate cyclic shifts for the respective mobile radio communication device; wherein a peak correlation power is a power of the correlation value calculated for the peak correlation cyclic shift for the respective mobile radio communication device.

In example 41, the subject matter of example 39 or example 40, wherein the other candidate cyclic shifts comprise the second subset of potential cyclic shifts and other potential cyclic shifts of the first subset of potential cyclic shifts that are not determined as the peak correlation cyclic shifts.

In example 42, the subject matter of any one of examples 38 to 41, wherein the instructions further cause the processor to calculate a correlation power for each radio communication device, the correlation power is representative of a power of correlation between the received radio signal and a cyclically shifted reference sequence; combine the correlation power for the plurality of radio communication devices from a plurality of receive antennas and OFDM symbols to obtain a combined correlation power; and identify the peak correlation cyclic shift is the cyclic shift having the maximum combined correlation power value for the respective mobile radio communication device among assigned candidate cyclic shifts of the respective mobile radio communication device.

In example 43, the subject matter of any one of examples 38 to 42, wherein the instructions further cause the processor to calculate a total peak correlation power, wherein the total peak correlation power is representative of the sum of the peak correlation power of mobile radio communication devices; wherein the noise power is based on a calculated signal power of the received radio signal and the total peak correlation power.

In example 44, the subject matter of example 43, wherein the instructions further cause the processor to calculate the noise power based on a difference of the calculated signal power and the total peak correlation power for each of the plurality of receive antennas and OFDM symbols.

In example 45, the subject matter of example 43 or example 44, wherein the instructions further cause the processor to decode the respective payload information based on the calculated metric that is based on the noise power and the correlation power for the respective mobile radio communication device.

In example 46, the subject matter of any one of examples 32 to 40, wherein the instructions further cause the processor to determine a plurality of candidate cyclic shift combinations, each combination of the plurality of candidate cyclic shift combinations including first candidate cyclic shifts from different mobile radio communication devices.

In example 47, the subject matter of example 46, wherein the instructions further cause the processor to select one of the plurality of candidate cyclic shift combinations based on calculated metrics for each combination of the plurality of combinations; wherein the first candidate cyclic shifts of the selected one of the plurality of candidate cyclic shift combinations define the candidate cyclic shifts for the plurality of mobile radio communication devices.

In example 48, the subject matter of example 46 or example 47, wherein the instructions further cause the processor to calculate a plurality of correlation values for each combination, each correlation value being based on the first candidate cyclic shifts of the respective combination; wherein each calculated correlation is representative of a similarity between a received radio signal and a reference sequence obtained based on a respective cyclic shift of the first candidate cyclic shifts.

In example 49, the subject matter of example 48, wherein the instructions further cause the processor to calculate the correlation value of each respective combination based on the received radio signal and the reference sequence.

In example 50, the subject matter of example 49, wherein the instructions further cause the processor to, for each combination, a plurality of first candidate correlation values, each first candidate correlation value is based on one of the first candidate cyclic shifts.

In example 51, the subject matter of example 50, wherein the instructions further cause the processor to estimate a noise power for each combination, each estimated noise power is based on second candidate cyclic shifts of the plurality of cyclic shifts and the first candidate cyclic shifts, wherein the second candidate cyclic shifts different from the first cyclic shifts.

In example 52, the subject matter of example 51, wherein the calculated metric for each candidate cyclic shift of the first candidate cyclic shifts and each combination is based on the respective correlation value and the noise power of the respective combination.

In example 53, the subject matter of example 52, wherein the calculated metric for each candidate cyclic shift of the first candidate cyclic shifts and each combination is a first cyclic shift and combination ratio of the power of respective correlation value to the noise power of the respective combination; wherein the instructions further cause the processor to select a candidate cyclic shift ratio as the highest first cyclic shift and combination ratio achieved with the candidate cyclic shift among the plurality of candidate cyclic shift combinations containing the candidate cyclic shift as the first candidate cyclic shifts; and select a ratio for a mobile radio communication device as having the highest ratio among the plurality of the candidate cyclic shifts of the mobile radio communication device.

In example 54, the subject matter of example 53 wherein the instructions further cause the processor to decode the payload information based on the selected ratio of the mobile radio communication device.

In example 55, the subject matter of any one of examples 33 to 54, wherein the instructions further cause the processor to determine whether the respective payload includes a symbol transmitted by the respective radio communication device based on a threshold applied to the calculated metric.

In example 56, the subject matter of example 55, wherein the instructions further cause the processor to determine whether there is a discontinuous transmission for the respective radio communication device based on the threshold applied to the calculated metric.

In example 57, the subject matter of any one of examples 32 to 56, wherein the received radio signal is a physical uplink control channel signal.

In example 58, the subject matter of example 57, wherein the respective payload information includes an uplink control information.

In example 59, a non-transitory computer-readable medium including one or more instructions which, if executed by a processor, cause the processor to: determine a received radio signal including payload information from a plurality of mobile radio communication devices, wherein the payload information is mapped to a resource block via applied cyclic shifts of a plurality of cyclic shifts; identify a first cyclic shifts from the plurality of cyclic shifts; correlate the received radio signal with cyclically shifted reference sequences that are shifted using the first set of candidate cyclic shifts; perform a noise power estimation based on second cyclic shifts of the plurality of cyclic shifts, wherein the second cyclic shifts are different from the first cyclic shifts.

In example 60, the non-transitory computer readable medium of example 59, wherein the one or more instructions further cause the processor to perform any other aspects described herein, in particular aspects described in any one of examples 32 to 58.

In example 61, the subject matter includes a method including: determining a received radio signal including payload information from a plurality of mobile radio communication devices, wherein the payload information is mapped to a resource block via a plurality of cyclic shifts; for each mobile radio communication device of the plurality of mobile radio communication devices, determining a candidate cyclic shift applied to a respective payload information of the payload information, wherein the candidate cyclic shifts for the plurality of mobile radio communication devices are determined from a plurality of candidate cyclic shifts; performing a noise power estimation using other candidate cyclic shifts of the plurality of candidate cyclic shifts, wherein the other candidate cyclic shifts are not determined as the candidate cyclic shifts.

In example 62, the subject matter of example 61, may further include: determining a noise power based on the other candidate cyclic shifts; and decode the respective payload information based on a calculated metric based on the noise power.

In example 63, the subject matter of example 62, may further include: decoding the respective payload information based on the candidate cyclic shift for the respective mobile radio communication device and the noise power.

In example 64, the subject matter of example 63, may further include: determining a first subset of potential cyclic shifts from the plurality of candidate cyclic shifts and a second subset of potential cyclic shifts from the plurality of candidate cyclic shifts; wherein the first subset of potential cyclic shifts including the candidate cyclic shifts.

In example 65, the subject matter of example 64, wherein the first subset of potential cyclic shifts includes predetermined candidate cyclic shifts from the plurality of candidate cyclic shifts.

In example 66, the subject matter of example 64 or example 65, wherein the first subset of potential cyclic shifts includes the candidate cyclic shifts assigned to the plurality of mobile radio communication devices.

In example 67, the subject matter of any one of examples 64 to 66, may further include: determining a correlation value for each potential cyclic shift of the first subset of potential cyclic shifts; and perform the noise power estimation using the second subset of potential cyclic shifts.

In example 68, the subject matter of example 67, may further include: determining, for each mobile radio communication device of the plurality of radio communication devices, the candidate cyclic shift applied to the respective payload information based on the correlation values.

In example 69, the subject matter of example 68, wherein, for each mobile radio communication device, a peak correlation cyclic shift is determined, the peak correlation cyclic shift being one of the candidate cyclic shifts from the first subset having the maximum correlation power value for the respective mobile radio communication device among the candidate cyclic shifts for the respective mobile radio communication device; wherein a peak correlation power is a power of the correlation value calculated for the peak correlation cyclic shift for the respective mobile radio communication device.

In example 70, the subject matter of example 68 or example 69, wherein the other candidate cyclic shifts comprise the second subset of potential cyclic shifts and other potential cyclic shifts of the first subset of potential cyclic shifts that are not determined as the peak correlation cyclic shifts.

In example 71, the subject matter of any one of examples 67 to 70, may further include: calculating a correlation power for each radio communication device, the correlation power is representative of a power of correlation between the received radio signal and a cyclically shifted reference sequence; combine the correlation power for the plurality of radio communication devices from a plurality of receive antennas and OFDM symbols to obtain a combined correlation power; and identifying the peak correlation cyclic shift is the cyclic shift having the maximum combined correlation power value for the respective mobile radio communication device among assigned candidate cyclic shifts of the respective mobile radio communication device.

In example 72, the subject matter of any one of examples 67 to 71, may further include: calculating a total peak correlation power, wherein the total peak correlation power is representative of the sum of the peak correlation power of mobile radio communication devices; wherein the noise power is based on a calculated signal power of the received radio signal and the total peak correlation power.

In example 73, the subject matter of example 72, may further include: calculating the noise power based on a difference of the calculated signal power and the total peak correlation power for each of the plurality of receive antennas and OFDM symbols.

In example 74, the subject matter of example 72 or example 73, may further include: decoding the respective payload information based on the calculated metric that is based on the noise power and the correlation power for the respective mobile radio communication device.

In example 75, the subject matter of any one of examples 61 to 69, may further include: determining a plurality of candidate cyclic shift combinations, each combination of the plurality of candidate cyclic shift combinations including first candidate cyclic shifts from different mobile radio communication devices.

In example 76, the subject matter of example 75, may further include: selecting one of the plurality of candidate cyclic shift combinations based on calculated metrics for each combination of the plurality of combinations; wherein the first candidate cyclic shifts of the selected one of the plurality of candidate cyclic shift combinations define the candidate cyclic shifts for the plurality of mobile radio communication devices.

In example 77, the subject matter of example 75 or example 76, may further include: calculating a plurality of correlation values for each combination, each correlation value being based on the first candidate cyclic shifts of the respective combination; wherein each calculated correlation is representative of a similarity between a received radio signal and a reference sequence obtained based on a respective cyclic shift of the first candidate cyclic shifts.

In example 78, the subject matter of example 77, may further include: calculating the correlation value of each respective combination based on the received radio signal and the reference sequence.

In example 79, the subject matter of example 78, may further include: for each combination, calculating a plurality of first candidate correlation values, each first candidate correlation value is based on one of the first candidate cyclic shifts.

In example 80, the subject matter of example 79, may further include: estimating a noise power for each combination, each estimated noise power is based on second candidate cyclic shifts of the plurality of cyclic shifts and the first candidate cyclic shifts, wherein the second candidate cyclic shifts different from the first cyclic shifts.

In example 81, the subject matter of example 80, wherein the calculated metric for each candidate cyclic shift of the first candidate cyclic shifts and each combination is based on the respective correlation value and the noise power of the respective combination.

In example 82, the subject matter of example 81, wherein the calculated metric for each candidate cyclic shift of the first candidate cyclic shifts and each combination is a first cyclic shift and combination ratio of the power of respective correlation value to the noise power of the respective combination; wherein the method further includes: selecting a candidate cyclic shift ratio as the highest first cyclic shift and combination ratio achieved with the candidate cyclic shift among the plurality of candidate cyclic shift combinations containing the candidate cyclic shift as the first candidate cyclic shifts; and selecting a ratio for a mobile radio communication device as having the highest ratio among the plurality of the candidate cyclic shifts of the mobile radio communication device.

In example 83, the subject matter of example 82 may further include: decoding the payload information based on the selected ratio of the mobile radio communication device.

In example 84, the subject matter of any one of examples 62 to 83, may further include: determining whether the respective payload includes a symbol transmitted by the respective radio communication device based on a threshold applied to the calculated metric.

In example 85, the subject matter of example 84, may further include: determining whether there is a discontinuous transmission for the respective radio communication device based on the threshold applied to the calculated metric.

In example 86, the subject matter of any one of examples 61 to 85, wherein the received radio signal is a physical uplink control channel signal.

In example 87, the subject matter of example 86, wherein the respective payload information includes an uplink control information.

In example 88, a method including: determining a received radio signal including payload information from a plurality of mobile radio communication devices, wherein the payload information is mapped to a resource block via applied cyclic shifts of a plurality of cyclic shifts; identifying a first cyclic shifts from the plurality of cyclic shifts; correlating the received radio signal with cyclically shifted reference sequences that are shifted using the first set of candidate cyclic shifts; performing a noise power estimation based on second cyclic shifts of the plurality of cyclic shifts, wherein the second cyclic shifts are different from the first cyclic shifts.

In example 89, the method of example 59, wherein the method further includes any other aspects described herein, in particular aspects described in any one of examples 61 to 87.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The terminology in accordance with open-RAN (O-RAN) specifications is to be considered for Radio Units (RUS), Distributed Units (DUs) and Centralized Units (CUs). Inherently, a base station is considered to be disaggregated into such units in accordance with layers of a corresponding protocol stack into these logical nodes, which all of them can be implemented by the same device or multiple devices in which each device may be deployed with one of these units.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel).

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. A radio communication device, comprising:
a memory; and
a processor configured to:
determine a received radio signal comprising payload information from a plurality of mobile radio communication devices, wherein the payload information is mapped to a resource block via a plurality of cyclic shifts;
for each mobile radio communication device of the plurality of mobile radio communication devices, determine a candidate cyclic shift applied to a respective payload information of the payload information, wherein the candidate cyclic shifts for the plurality of mobile radio communication devices are determined from a plurality of candidate cyclic shifts;
perform a noise power estimation using other candidate cyclic shifts of the plurality of candidate cyclic shifts, wherein the other candidate cyclic shifts are not determined as the candidate cyclic shifts.

2. The radio communication device of claim 1,
wherein the processor is further configured to determine a noise power based on the other candidate cyclic shifts;
wherein the processor is further configured to decode the respective payload information based on a calculated metric based on the noise power.

3. The radio communication device of claim 2,
wherein the processor is further configured to decode the respective payload information based on the candidate cyclic shift for the respective mobile radio communication device and the noise power;
wherein the first subset comprises the candidate cyclic shifts that are assigned to the plurality of mobile radio communication devices.

4. The radio communication device of claim 3,
wherein the processor is further configured to determine a correlation value for each candidate cyclic shift of the first subset;
wherein the processor is further configured to perform the noise power estimation using the candidate cyclic shifts of the second subset.

5. The radio communication device of claim 4,
wherein the processor is further configured to determine, for each mobile radio communication device of the plurality of radio communication devices, the candidate cyclic shift applied to the respective payload information based on the correlation values.

6. The radio communication device of claim 5,
wherein, for each mobile radio communication device, a peak correlation cyclic shift is determined, the peak correlation cyclic shift being one of the candidate cyclic shifts from the first subset having the maximum correlation power value for the respective mobile radio communication device among the candidate cyclic shifts assigned to the respective mobile radio communication device;
wherein a peak correlation power is a power of the correlation value calculated for the peak correlation cyclic shift for the respective mobile radio communication device.

7. The radio communication device of claim 6,
wherein the other candidate cyclic shifts comprise the second subset of potential cyclic shifts and other potential cyclic shifts of the first subset of potential cyclic shifts that are not determined as the peak correlation cyclic shifts.

8. The radio communication device of claim 6,
wherein the processor is configured to calculate a correlation power for each mobile radio communication device, the correlation power is representative of a power of correlation between the received radio signal and a cyclically shifted reference sequence;
wherein the processor is further configured to combine the correlation power for the plurality of mobile radio communication devices from a plurality of receive antennas and OFDM symbols to obtain a combined correlation power;
wherein the processor is further configured to identify the peak correlation cyclic shift is the cyclic shift having the maximum combined correlation power value for the respective mobile radio communication device among assigned candidate cyclic shifts of the respective mobile radio communication device.

9. The radio communication device of claim 6,
wherein the processor is further configured to calculate a total peak correlation power,
wherein the total peak correlation power is representative of the sum of the peak correlation power of mobile radio communication devices;
wherein the noise power is based on a calculated signal power of the received radio signal and the total peak correlation power.

10. The radio communication device of claim 9,
wherein the processor is further configured to calculate the noise power based on a difference of the calculated signal power and the total peak correlation power for each of the plurality of receive antennas and OFDM symbols.

11. The radio communication device of claim 1,
wherein the processor is further configured to determine a plurality of candidate cyclic shift combinations, each combination of the plurality of candidate cyclic shift combinations comprising one assigned candidate cyclic shift for each mobile radio communication device.

12. The radio communication device of claim 11,
wherein the processor is further configured to calculate a plurality of correlation values, each correlation value of the plurality of correlation values corresponding to one of the combinations, and being based on the respective assigned candidate cyclic shifts of the respective combination;
wherein each calculated correlation value is representative of a similarity between a received radio signal and a reference sequence obtained based on a respective cyclic shift of the respective assigned candidate cyclic shifts.

13. The radio communication device of claim 12,
wherein the processor is further configured to estimate a noise power for each combination, each estimated noise power is based on remaining candidate cyclic shifts of the plurality of candidate cyclic shifts, wherein the remaining candidate cyclic shifts are distinct from the respective assigned candidate cyclic shifts of the respective combination.

14. The radio communication device of claim 2,
wherein the processor is further configured to determine whether there is a discontinuous transmission for the respective radio communication device based on the threshold applied to the calculated metric.

15. A radio communication device, comprising:
a memory; and
a processor configured to:
determine a received radio signal comprising payload information from a plurality of mobile radio communication devices, wherein the payload information is mapped to a resource block via applied cyclic shifts of a plurality of cyclic shifts;
identify a first cyclic shifts from the plurality of cyclic shifts;
correlate the received radio signal with cyclically shifted reference sequences that are shifted using the first set of candidate cyclic shifts;
perform a noise power estimation based on second cyclic shifts of the plurality of cyclic shifts, wherein the second cyclic shifts are different from the first cyclic shifts.

16. The radio communication device of claim 15,
wherein the processor is further configured to decode the respective payload information based on the noise power estimation.

17. A non-transitory computer-readable medium comprising one or more instructions which, if executed by a processor, cause the processor to:
determine a received radio signal comprising payload information from a plurality of mobile radio communication devices, wherein the payload information is mapped to a resource block via a plurality of cyclic shifts;
for each mobile radio communication device of the plurality of mobile radio communication devices, determine a candidate cyclic shift applied to a respective payload information of the payload information, wherein the candidate cyclic shifts for the plurality of mobile radio communication devices are determined from a plurality of candidate cyclic shifts;
perform a noise power estimation using other candidate cyclic shifts of the plurality of candidate cyclic shifts, wherein the other candidate cyclic shifts are not determined as the candidate cyclic shifts.

18. The non-transitory computer-readable medium of claim 17,
wherein the instructions further cause the processor to determine a noise power based on the other candidate cyclic shifts; and decode the respective payload information based on a calculated metric based on the noise power.

19. The non-transitory computer-readable medium of claim 18,
wherein the processor is further configured to determine whether there is a discontinuous transmission for the respective radio communication device based on the threshold applied to the calculated metric.

20. The non-transitory computer-readable medium of claim 17,
wherein the instructions further cause the processor to determine a plurality of candidate cyclic shift combinations, each combination of the plurality of candidate cyclic shift combinations comprising one assigned candidate cyclic shift for each mobile radio communication device.
